(19) United States
(12) Patent Application Publication
(10) Pub. No.: US 2026/0276461 A1
(43) Pub. Date: Sep. 17, 2026

(54) FORCE SENSOR, SENSOR MODULE, AND ROBOT HAND

(71) Applicant: SONY GROUP CORPORATION, TOKYO (JP)

(72) Inventor: AKIHIRO NOMOTO, TOKYO (JP)

(21) Appl. No.: 18/869,108

(22) PCT Filed: May 19, 2023
(86) PCT No.: PCT/JP2023/018789

§ 371 Date: Nov. 25, 2024

(30) Foreign Application Priority Data
Jun. 3, 2022 (JP) 2022-091132

(51) Int. Cl. G01L 1/24; B25J 13/08; G01L 5/00

(52) U.S. Cl. CPC G01L 1/24; B25J 13/084; G01L 5/0061

(57) ABSTRACT

Provided is a force sensor capable of obtaining a wide dynamic range and high sensitivity. The force sensor includes a light receiving unit group, a reflection unit provided above the light receiving unit group, and an elastic body provided between the reflection unit and the light receiving unit group. The light receiving unit group includes four or more first light receiving units arranged in a first direction and four or more second light receiving units arranged in a second direction orthogonal to the first direction.

### TECHNICAL FIELD

The present disclosure relates to a force sensor, a sensor module including the force sensor, and a robot hand.

### BACKGROUND ART

A force sensor capable of acquiring a force distribution of three axes is desired in order to detect strength and a direction of a force applied to an object by a robot hand and realize stable gripping of the object and operation of the object. As one of the force sensors, there is an optical triaxial force sensor. The optical triaxial force sensor usually includes a light source, a reflector, and two pairs of light receiving units as components. Of the two pairs of light receiving units, the first pair of light receiving units is arranged in the X direction, and the second pair of light receiving units is arranged in the Y direction (see, for example, Patent Document 1).

### CITATION LIST

### Patent Document

Patent Document 1: WO 2014/045865 A

### SUMMARY OF THE INVENTION

### Problems to be Solved by the Invention

However, in the optical triaxial force sensor having the above configuration, the dynamic range may become narrower and the sensitivity may be lowered.

An object of the present disclosure is to provide a force sensor capable of obtaining a wide dynamic range and high sensitivity, and a sensor module and a robot hand including the force sensor.

### Solutions to Problems

In order to solve the above problem, a first force sensor according to the present disclosure includes:
a light receiving unit group;
a reflection unit provided above the light receiving unit group; and
an elastic body provided between the reflection unit and the light receiving unit group,
in which the light receiving unit group includes:
four or more first light receiving units arranged in a first direction; and
four or more second light receiving units arranged in a second direction orthogonal to the first direction.

A second force sensor according to the present disclosure includes:
a plurality of light receiving unit groups;
a plurality of reflection units provided above each of the light receiving unit groups; and
an elastic layer provided between the plurality of reflection units and the plurality of light receiving unit groups,
in which the light receiving unit group includes
four or more first light receiving units arranged in a first direction, and
four or more second light receiving units arranged in a second direction orthogonal to the first direction.

A sensor module according to the present disclosure includes at least one of the first force sensor and the second force sensor.

A robot hand according to the present disclosure includes at least one of the first force sensor and the second force sensor.

### BRIEF DESCRIPTION OF DRAWINGS

FIG. 1 is a block diagram illustrating an example of a configuration of a sensor module according to one embodiment.

FIG. 2 is a cross-sectional view illustrating an example of a configuration of a sensor.

FIG. 3 is a plan view illustrating an example of a configuration of a light receiving unit group.

FIG. 4 is a graph illustrating an example of a difference SX_{A1,A4} between output signals, a difference SX_{A2,A4} between output signals, and a difference SX_{A3,A6} between output signals.

FIG. 5 is a graph illustrating an example of a difference SY_{B1,B4} between output signals, a difference SY_{B2,B4} between output signals, and a difference SY_{B3,B6} between output signals.

FIG. 6A is a diagram illustrating an example of a light distribution, a sum QZ_{A2,A5} of light amounts, and a difference QX_{A2,A5} between the light amounts when a displacement amount ΔX at a center position of a reflection unit is ΔX=0. FIG. 6B is a diagram illustrating an example of a light distribution, a sum QZ_{A2,A5} of light amounts, and a difference QX_{A2,A5} between the light amounts when a displacement amount ΔX at a center position of a reflection unit is ΔX=d. FIG. 6C is a diagram illustrating an example of a light distribution, a sum QZ_{A2,A5} of light amounts, and a difference QX_{A2,A5} between the light amounts when a displacement amount ΔX at a center position of a reflection unit is ΔX=2d.

FIG. 7A is a graph illustrating an example of the difference SX_{A1,A4} between the output signals. FIG. 7B is a graph illustrating an example of the difference SX_{A2,A5} between the output signals. FIG. 7C is a graph illustrating an example of the difference SX_{A3,A6} between the output signals.

FIG. 8A is a schematic diagram illustrating an example of a region R_{A1,A4} in which an error of the difference SX_{A1,A4} between the output signals is small. FIG. 8B is a schematic diagram illustrating an example of a region R_{A2,A5} in which an error of the difference SX_{A2,A5} between the output signals is small. FIG. 8C is a schematic diagram illustrating an example of a region R_{A3,A6} in which an error of the difference SX_{A3,A6} between the output signals is small. FIG. 8D is a schematic diagram illustrating an example of a region R_{A1,A6} in which the region R_{A1,A4}, the region R_{A2,A5}, and the region R_{A3,A6} are integrated.

FIG. 9A is a graph illustrating an example of the difference SY_{B1,B4} between the output signals. FIG. 9B is a graph illustrating an example of the difference SY_{B2,B5} between the output signals. FIG. 9C is a graph illustrating an example of the difference SY_{B3,B6} between the output signals.

FIG. 10A is a schematic diagram illustrating an example of a region R_{A1,A4} in which an error of the difference SY_{B1,B4} between the output signals is small. FIG. 10B is a schematic diagram illustrating an example of a region R_{A2,A5} in which an error of the difference SY_{B2,B5} between the output signals is small. FIG. 10C is a schematic diagram illustrating an example of a region R_{A3,A6} in which an error of the difference SY_{B3,B6} between the output signals is small. FIG. 10D is a schematic diagram illustrating an example of a region R_{B1,B6} in which the region R_{B1,B4}, the region R_{B2,B5}, and the region R_{B3,B6} are integrated.

FIG. 11 is a flowchart for explaining an example of a detection operation of a force F_{Z} by the sensor module.

FIG. 12 is a flowchart for explaining an example of a first detection operation of forces F_{X} and F_{Y} by the sensor module.

FIG. 13 is a flowchart for explaining an example of a second detection operation of the forces F_{X} and F_{Y} by the sensor module.

FIG. 14A is a side view illustrating a model of optical simulation. FIG. 14B is a plan view illustrating a model of optical simulation.

FIG. 15 is a diagram illustrating an illuminance distribution obtained by optical simulation.

FIG. 16A is a diagram illustrating a sum SZ of signals obtained by optical simulation. FIG. 16B is a graph illustrating the sum SZ of the signals at the position of the broken line in FIG. 16A.

FIG. 17A is a diagram illustrating a difference SX between output signals obtained by optical simulation. FIG. 17B is a graph illustrating the difference SX between the output signals at a position indicated by the broken line in FIG. 17A.

FIG. 18 is a diagram illustrating a difference SY between output signals obtained by optical simulation.

FIG. 19A is a perspective view illustrating an example of a shape of a sensor of Modification 1. FIG. 19B is a cross-sectional view taken along line XIXB-XIXB in FIG. 19A.

FIG. 20 is an enlarged cross-sectional view of a part of FIG. 19B.

FIG. 21 is a cross-sectional view illustrating an example of a configuration of a sensor of Modification 2.

FIG. 22 is a cross-sectional view illustrating an example of a configuration of a sensor of Modification 3.

FIG. 23 is a cross-sectional view illustrating an example of a configuration of a sensor of Modification 4.

FIG. 24 is a cross-sectional view illustrating an example of a configuration of a sensor of Modification 5.

FIG. 25 is a cross-sectional view illustrating an example of a configuration of a sensor of Modification 6.

FIG. 26 is a cross-sectional view illustrating an example of a configuration of a sensor of Modification 7.

FIG. 27 is a cross-sectional view illustrating an example of a configuration of a sensor of Modification 8.

FIG. 28 is a cross-sectional view illustrating an example of a configuration of a sensor of Modification 9.

FIG. 29 is a plan view illustrating an example of a configuration of a light receiving unit.

FIG. 30 is a cross-sectional view illustrating an example of a configuration of a sensor according to Modification 10.

FIG. 31 is a cross-sectional view illustrating an example of a configuration of a sensor of Modification 11.

FIG. 32 is a plan view illustrating an example of a configuration of a light receiving unit group of Modification 12.

FIG. 33 is a plan view illustrating an example of a configuration of a light receiving unit.

FIG. 34 is a plan view for explaining an example of an operation of detecting the forces F_{X} and F_{Y} by the sensor module.

FIG. 35 is a plan view for explaining an example of the operation of detecting the forces F_{X} and F_{Y} by the sensor module.

FIG. 36 is a plan view for explaining an example of the operation of detecting the forces F_{X} and F_{Y} by the sensor module.

FIG. 37 is a plan view for explaining an example of the operation of detecting the forces F_{X} and F_{Y} by the sensor module.

FIG. 38 is a plan view illustrating an example of a configuration of a light receiving unit group of Modification 13.

FIG. 39 is a schematic diagram illustrating an example of a configuration of a robot hand of Specific Example 1.

FIG. 40 is a schematic diagram illustrating an example of a configuration of a robot hand of Specific Example 2.

FIG. 41 is a schematic diagram illustrating an example of a configuration of a robot hand of Specific Example 3.

### MODE FOR CARRYING OUT THE INVENTION

An embodiment of the present disclosure will be described in the following order with reference to the drawings. Note that the same or corresponding portions will be denoted by the same reference signs in all the drawings of the following embodiment.
1 One embodiment (example of sensor and sensor module)
2 Modification (modifications of sensor, modifications of light receiving unit group, and other modifications)
3 Application example (Application example to robot hand)

### 1 One Embodiment

### [Configuration of Sensor Module 10]

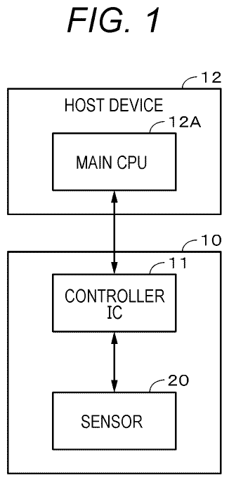

FIG. 1 is a block diagram illustrating an example of a configuration of a sensor module 10 according to one embodiment. The sensor module 10 includes a sensor 20 and an IC 11. The sensor module 10 may be provided in a robot hand, an electronic device, or the like. The sensor module 10 is connected to, for example, a main central processing unit (CPU) 12A included in a host device 12.

### (Sensor 20)

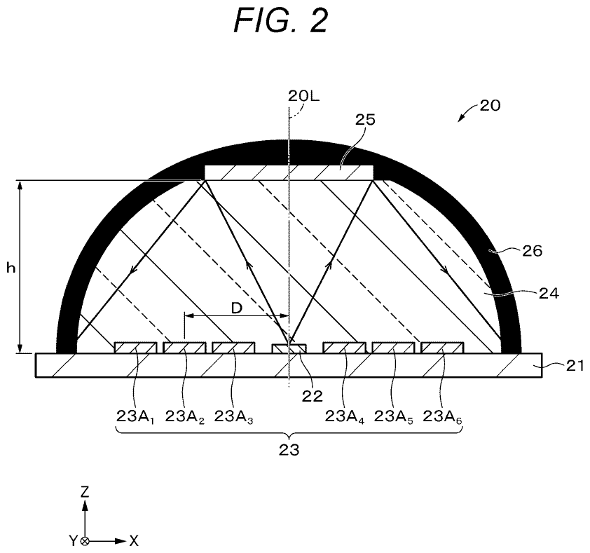

FIG. 2 is a cross-sectional view illustrating an example of a configuration of the sensor 20. The sensor 20 is an optical triaxial force sensor. The sensor 20 includes a base material 21, a light source 22, a light receiving unit group 23, an elastic body 24, a reflection unit 25, and a light shielding layer 26. The sensor 20 has a dome shape. Here, the dome shape represents a hemispherical shape or a convex shape similar thereto. The convex shape includes shapes such as a substantially parabolic shape, a substantially hemispherical shape, and a substantially semi-elliptical sphere. The sensor 20 has a central axis 20L passing through the top of the dome-shaped curved surface and the center of the circular bottom surface in a state where no force is applied to the dome-shaped curved surface of the sensor 20.

### (Base Material 21)

The base material 21 supports the light source 22, the light receiving unit group 23, the elastic body 24, and the light shielding layer 26. The base material 21 has a first surface on the reflection unit 25 side and a second surface opposite to the first surface. In the present embodiment, a direction parallel to the central axis 20L, that is, a direction perpendicular to the first surface of the base material 21 is referred to as a Z direction (third direction). Two directions orthogonal to the Z direction and orthogonal to each other, that is, two directions orthogonal to each other in a plane parallel to the first surface of the base material 21 are referred to as an X direction (first direction) and a Y direction (second direction). The first surface and the second surface have a circular shape in plan view. The plan view represents a plan view when the object is viewed from the +Z direction or the −Z direction. The base material 21 may include a light absorbing layer on the first surface side.

The light source 22, the light receiving unit group 23, the elastic body 24, and the light shielding layer 26 are provided on the first surface of the base material 21. The light source 22 and/or the light receiving unit group 23 may be formed directly on the first surface of the base material 21 or may be bonded. Here, “and/or” means at least one of them, and for example, in the case of “X and/or Y”, it means three ways of only X, only Y, X and Y.

In the present embodiment, the center position of the reflection surface of the reflection unit 25 in the Z direction with respect to the first surface of the base material 21 is referred to as a height Z of the reflection unit 25 or a position Z of the reflection unit 25. The reflection surface center position of the reflection unit 25 in the X direction with respect to a central axis 20h of the base material 21 is referred to as a position X of the reflection unit 25. A reflection surface center position of the reflection unit 25 in the Y direction with respect to the central axis 20h of the base material 21 is referred to as a position Y of the reflection unit 25. Here, the reflective-surface center position represents a geometric center position of the reflection surface in plan view.

The base material 21 is, for example, a substrate or a film. The substrate may have rigidity or flexibility. The substrate may be made of, for example, a semiconductor in which the light source 22 and/or the light receiving unit group 23 and the like are easily formed, or may be made of glass or resin having low moisture and oxygen permeability. Specifically, the substrate may be a semiconductor substrate, a glass substrate, a resin substrate, or the like. The semiconductor substrate includes, for example, amorphous silicon, polycrystalline silicon, monocrystalline silicon, or the like. The glass substrate contains, for example, high strain point glass, soda glass, borosilicate glass, forsterite, lead glass, quartz glass, or the like. The resin substrate contains, for example, at least one selected from a group including polymethyl methacrylate, polyvinyl alcohol, polyvinyl phenol, polyethersulfone, polyimide, polycarbonate, polyethylene terephthalate, polyethylene naphthalate, and the like. The base material 21 may include an insulating layer on the first surface side as necessary.

### (Light Source 22)

The light source 22 can emit light toward the reflection unit 25. The light that can be emitted from the light source 22 is not particularly limited, and may be, for example, any of visible light, ultraviolet light, and infrared light. The visible light may be white light, red light, green light, blue light, or light of a color other than these. The light source 22 is provided at a geometric center position of the first surface of the base material 21. The light source 22 is located immediately below the reflection unit 25 in a state where no force is applied to the dome-shaped curved surface of the sensor 20. The geometric center position (hereinafter, it is simply referred to as a “center position of the light source 22”) of the light exit surface of the light source 22 is located on the central axis 20L in a state where no force is applied to the dome-shaped curved surface of the sensor 20. The light source 22 includes, for example, a light emitting element such as a light emitting diode (LED) element, a laser diode (LD) element, a super luminescent diode (SLD) element, or an organic light emitting diode (OLED) element. The light source 22 may be a surface mount device (SMD) or the like in which a light emitting element is packaged, or may be a light emitting element wired on the base material 21 by wire bonding or the like.

### (Light Receiving Unit Group 23)

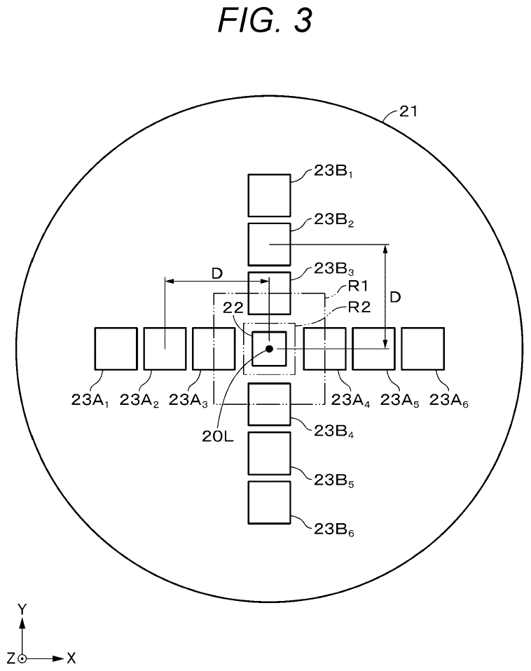

FIG. 3 is a plan view illustrating an example of a configuration of the light receiving unit group 23. The light receiving unit group 23 includes first light receiving units 23A₁ to 23A₆ and second light receiving units 23B₁ to 23B₆. In the following description, the first light receiving units 23A₁ to 23A₆ may be collectively referred to as first light receiving units 23A. In addition, the second light receiving units 23B₁ to 23B₆ may be collectively referred to as second light receiving units 23B. In the present embodiment, an example in which the sensor 20 includes six first light receiving units 23A₁ to 23A₆ and six second light receiving units 23B₁ to 23B₆ will be described, but the number of first light receiving units 23A and second light receiving units 23B is not limited thereto. For example, the number of the first light receiving units 23A and the second light receiving units 23B may be 4, 5, or 7 or more. The number of the first light receiving units 23A and the second light receiving units 23B is preferably an even number.

The first light receiving units 23A₁ and 23A₆ and the second light receiving units 23B₁ and 23B₆ may be used in a case where the height Z of the reflection unit 25 is high, for example, in a case where the height Z falls within the range of h₁<Z. The first light receiving units 23A₃ and 23A₄ and the second light receiving units 23B₃ and 23B₄ may be used in a case where the height Z of the reflection unit 25 is low, for example, in a case where the height Z of the reflection unit 25 falls within the range of Z<h₂. The first light receiving units 23A₂ and 23A₅ and the second light receiving units 23B₂ and 23B₅ may be used, for example, in a case where Z falls within the range of h₂≥Z≤h₁. In a case where the first light receiving units 23A₁ to 23A₆ are used in a switched manner as a pair, all of the first light receiving unit 23A₁ to 23A₆ may be used regardless of the height Z of the reflection unit 25. In a case where the second light receiving units 23B₁ to 23B₆ are used in a switched manner as a pair, all of the second light receiving units 23B₁ to 23B₆ may be used regardless of the height Z of the reflection unit 25.

The first light receiving units 23A₁ to 23A₆ and the second light receiving units 23B₁ to 23B₆ can receive the light reflected by the reflection unit 25. The first light receiving units 23A₁ to 23A₆ and the second light receiving units 23B₁ to 23B₆ can convert the received light into an electric signal and supply the electric signal to the IC 11. The first light receiving units 23A₁ to 23A₆ are arranged in the X direction to form a row. The first light receiving units 23A₁ to 23A₆ constituting the row are arranged symmetrically with respect to the center of the light receiving unit group 23, that is, with respect to the geometric center of the light source 22. The second light receiving units 23B₁ to 23B₆ are arranged in the Y direction to form a row. The second light receiving units 23B₁ to 23B₆ constituting the row are arranged symmetrically with respect to the center of the light receiving unit group 23, that is, with respect to the geometric center of the light source 22. A distance D_{A1} between the adjacent first light receiving units 23A₁ and 23A₂, a distance D_{A2} between the adjacent first light receiving units 23A₂ and 23A₃, a distance D_{A3} between the adjacent first light receiving units 23A₄ and 23A₅, and a distance D_{A4} between the adjacent first light receiving units 23A₅ and 23A₆ may be the same (that is, D_{A1}=D_{A2}=D_{A3}=D_{A4}). A distance D_{B1} between the adjacent second light receiving units 23B₁ and 23B₂, a distance D_{B2} between the adjacent second light receiving units 23B₂ and 23B₃, a distance D_{B3} between the adjacent second light receiving units 23B₄ and 23B₅, and a distance D_{B4} between the adjacent second light receiving units 23B₅ and 23B₆ may be the same (that is, D_{B1}=D_{B2}=D_{B3}=D_{B4}). The distance between the adjacent first light receiving units 23A and the distance between the adjacent second light receiving units 23B may be the same (that is, D_{A1}=D_{A2}=D_{A3}=D_{A4}=D_{B1}=D_{B2}=D_{B3}=D_{B4}).

Each of the first light receiving units 23A₁ to 23A₆ and the second light receiving units 23B₁ to 23B₆ includes one or more light receiving elements. The light receiving element is, for example, a photodiode, an avalanche photodiode, or a phototransistor. Each of the first light receiving units 23A₁ to 23A₆ and the second light receiving units 23B₁ to 23B₆ may be a surface mount device (SMD) or the like in which one or two or more light receiving elements are packaged, or may be one or two or more light receiving elements wired on the base material 21 by wire bonding or the like. The first light receiving units 23A₁ to 23A₆ and the second light receiving units 23B₁ to 23B₆ may be mounted on the base material 21 via a connection member such as a bump, or may be directly formed on the base material 21 by patterning amorphous silicon or the like, for example.

From the viewpoint of suppressing the detection error of the force acting on the sensor 20, the first light receiving units 23A₂ and 23A₅ and the second light receiving units 23B₂ and 23B₅ preferably satisfy the relationship of 1.6×D≤h≤2.4×D, and more preferably satisfy the relationship of h=2D. Here, h is the height of the reflection surface of the reflection unit 25 with respect to the first surface of the base material 21. D is a distance from the center position (that is, the intersection position between the central axis 20L and the first surface of the base material 21) of the light source 22 to the center of the first light receiving unit 23A₂ or the center position of the second light receiving unit 23B₂. Here, the center positions of the first light receiving unit 23A₂ and the second light receiving unit 23B₂ represent the geometric center positions of the first light receiving unit 23A₂ and the second light receiving unit 23B₂ in plan view. As described above, the center position of the light source 22 represents the geometric center position of the light exit surface of the light source 22 in plan view. The arrangement of the first light receiving units 23A₁ to 23A₆ and the second light receiving units 23B₁ to 23B₆ is preferably adjusted on the basis of a state in which the distance between the reflection unit 25 and the base material 21 is small.

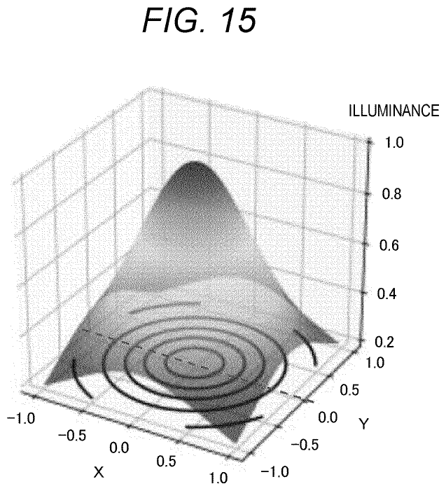

From the viewpoint of suppressing the detection error of the force acting on the sensor 20, the first light receiving units 23A₁ to 23A₆ and the second light receiving units 23B₁ to 23B₆ are preferably provided in a linear region in which the light distribution (see FIG. 15) of the reflected light by the reflection unit 25 changes substantially linearly (substantially linear). The light distribution of the reflected light by the reflection unit 25 may be the light distribution of the reflected light by the reflection unit 25 in a state where the forces in the +X direction, the +Y direction, and the −Z direction are not applied to the sensor 20, or may be the light distribution of the reflected light by the reflection unit 25 in a state where the forces in the +X direction and the +Y direction are not applied to the sensor 20 and the force (specified force) is applied only to the sensor 20 in the −Z direction.

### (Elastic Body 24)

The elastic body 24 can be elastically deformed in the +X direction, the +Y direction, and the −Z direction. The elastic body 24 has translucency with respect to light emitted from the light source 22. For example, in a case where the light source 22 is configured to be able to emit visible light such as white light, red light, green light, or blue light, the elastic body 24 may have transparency with respect to the visible light. The elastic body 24 may be colored.

The elastic body 24 has a dome shape. The elastic body 24 supports the reflection unit 25 at a dome-shaped top. The elastic body 24 is provided between the reflection unit 25 and the light receiving unit group 23. The elastic body 24 is disposed on the first surface of the base material 21 such that the bottom surface of the elastic body 24 is on the first surface side of the base material 21. The elastic body 24 includes, for example, at least one of an elastomer and a gel. The elastomer includes, for example, at least one selected from the group consisting of a silicone-based elastomer, an acrylic-based elastomer, a urethane-based elastomer, a styrene-based elastomer, and the like. The gel contains, for example, at least one polymer gel selected from the group consisting of a silicone gel, a urethane gel, an acrylic gel, and a styrene gel. As the material of the elastic body 24, materials having various hardnesses can be selected. The sensitivity range of the sensor 20 can be adjusted by selecting the material hardness of the elastic body 24.

### (Reflection Unit 25)

The reflection unit 25 can reflect the light emitted from the light source 22 toward the first surface of the base material 21. That is, the reflection unit 25 can reflect the light emitted from the light source 22 toward the first surface of the light receiving unit group 23. The reflection by the reflection unit 25 is, for example, specular reflection or diffuse reflection. The reflection unit 25 has, for example, a reflection surface that reflects the light emitted from the light source 22 and a back surface opposite to the reflection surface. The reflection surface is, for example, a mirror surface or a diffusion surface.

The reflection unit 25 is provided above the light receiving unit group 23. The reflection unit 25 is located immediately above the light source 22 in a state where no force is applied to the dome-shaped curved surface of the sensor 20. Specifically, in a state where no force is applied to the dome-shaped curved surface of the sensor 20, the geometric center position (hereinafter, it is simply referred to as a “center position of the reflection unit 25”) of the reflection surface of the reflection unit 25 is located on the central axis 20L. In addition, in a state where no force is applied to the dome-shaped curved surface of the sensor 20, the reflection surface of the reflection unit 25 is held in parallel with the first surface of the base material 21. The reflection unit 25 is held at a top of the elastic body 24. The center position (position in the X direction, the Y direction, and the Z direction) of the reflection unit 25 is changed by the deformation of the elastic body 24. This positional change causes the reflection unit 25 to change the orientation distribution of the reflected light. The reflection unit 25 has, for example, a circular shape or a regular polygonal shape (for example, a square shape) in plan view.

The reflection unit 25 is a reflection layer capable of specular reflection or a diffuse reflection layer capable of diffuse reflection (scattering). The reflection layer is, for example, a metal layer. The metal layer contains, for example, at least one selected from the group consisting of chromium (Cr), gold (Au), platinum (Pt), nickel (Ni), copper (Cu), molybdenum (Mo), titanium (Ti), tantalum (Ta), aluminum (Al), magnesium (Mg), iron (Fe), tungsten (W), and silver (Ag). The diffuse reflection layer includes, for example, particles as a light scattering body. More specifically, the diffuse reflection layer is a white layer containing white silicone or the like, a white film (for example, a white PET film), or the like.

### (Light Shielding Layer 26)

The light shielding layer 26 can absorb incident light. The incident light is, for example, external light, emitted light of the light source 22, and the like. The light shielding layer 26 can be deformed together with the elastic body 24. The light shielding layer 26 is provided on the dome-shaped curved surface of the elastic body 24, and covers the dome-shaped curved surface of the elastic body 24 and the back surface (surface opposite to the reflection surface) of the reflection unit 25.

The light shielding layer 26 includes, for example, a light absorbing material and a binder. The light absorbing material includes, for example, a black pigment. The black pigment contains, for example, at least one selected from the group consisting of carbon black, titanium black, and the like. The titanium black is black particles containing titanium atoms, and preferably contains at least one of low order titanium oxide and titanium oxynitride. The black pigment may be surface-modified as necessary for the purpose of improving dispersibility, suppressing cohesiveness, and the like. Specifically, the light shielding layer 26 may contain, for example, black silicone.

The binder preferably has elasticity. The binder contains, for example, at least one selected from the group consisting of a silicone-based resin, an acrylic resin, a urethane-based resin, and the like.

### (IC11)

The IC 11 drives the light source 22 to emit light from the light source 22 toward the reflection unit 25. The IC 11 scans the first light receiving units 23A₁ to 23A₆ and the second light receiving units 23B₁ to 23B₆, obtains output signals S_{A1} to S_{A6} from the first light receiving units 23A₁ to 23A₆, and obtains output signals S_{B1} to S_{B6} from the second light receiving units 23B₁ to 23B₆. The scan order of the first light receiving units 23A₁ to 23A₆ and the second light receiving units 23B₁ to 23B₆ by the IC 11 is not particularly limited.

### (Detection of Force F_{Z} Acting in Z Direction)

The IC 11 calculates a sum S_{Z1} (=S_{A1}+S_{A6}+S_{B1}+S_{B6}) of the output signals using the output signals S_{A1} and S_{A6} of the pair of the first light receiving units 23A₁ and 23A₆ and the output signals S_{B1} and S_{B6} of the pair of the second light receiving units 23B₁ and 23B₆.

The IC 11 calculates a sum S_{Z2} (=S_{A2}+S_{A5}+S_{B2}+S_{B5}) of the output signals using the output signals S_{A2} and S_{A5} of the pair of the first light receiving units 23A₂ and 23A₅ and the output signals S_{B2} and S_{B5} of the pair of the second light receiving units 23B₂ and 23B₅.

As the distance between the center position of the reflection unit 25 and the base material 21 becomes smaller (that is, as the center position of the reflection unit 25 in the Z direction becomes lower), the light distribution of the reflected light by the reflection unit 25 decreases. Therefore, as the distance between the center position of the reflection unit 25 and the base material 21 becomes smaller, a region in which the detection error of the sum SZ of the output signals is small with respect to the position change of the reflection unit 25 in the X and Y directions becomes narrower. The region in which the detection error of the sum SZ of the output signals is small represents a region in which the sum SZ of the output signals is substantially constant with respect to the position change of the reflection unit 25 in the X and Y directions. The sum SZ of the output signals corresponds to the force (pressing force) F_{Z} acting in the Z direction. The sum SZ of the output signals changes substantially linearly (substantially linear) with respect to the change in the distance between the center position of the reflection unit 25 and the base material 21.

From the viewpoint of the above characteristics, the IC 11 operates as follows according to the distance between the reflection unit 25 and the base material 21.

In a case where the distance between the center position of the reflection unit 25 and the base material 21 is larger than a specified value, the IC 11 calculates the force F_{Z} acting in the Z direction on the basis of the sum S_{Z1} of the output signals, and outputs the force F_{Z} to a main CPU 12A. In a case where the distance between the center position of the reflection unit 25 and the base material 21 becomes smaller than the specified value, the IC 11 calculates the force F_{Z} acting in the Z direction on the basis of the sum S_{Z2} of the output signals, and outputs the force F_{Z} to the main CPU 12A.

The IC 11 performs the position detection processing according to the distance between the center position of the reflection unit 25 and the base material 21 as described above, so that the dynamic range of the sensor module 10 can be expanded.

The IC 11 determines whether or not the distance between the center position of the reflection unit 25 and the base material 21 is smaller than the specified value on the basis of whether or not the sum S_{Z1} of the output signals is larger than the specified value S_{Z0}. That is, in a case where the sum S_{Z1} of the output signals is larger than the specified value S_{Z0}, the IC 11 determines that the distance between the center position of the reflection unit 25 and the base material 21 is larger than the specified value. On the other hand, in a case where the sum S_{Z1} of the output signals is equal to or less than the specified value S_{Z0}, the IC 11 determines that the distance between the center position of the reflection unit 25 and the base material 21 is smaller than the specified value.

(Detection of Forces F_{X} and F_{Y} Acting in X and Y Directions in a Case where the Distance Between the Reflection Unit 25 and the Base Material 21 is Large)

As the distance between the center position of the reflection unit 25 and the base material 21 becomes larger, the light distribution of the reflected light by the reflection unit 25 is enlarged. Therefore, as the distance between the center position of the reflection unit 25 and the base material 21 becomes larger, regions in which the detection errors of the differences SX (=(S_{Am}−S_{An})/(S_{Am}+S_{An})) and SY (=(S_{Bm}−S_{Bn})/(S_{Bm}+S_{Bn})) between the output signals with respect to the position changes of the reflection unit 25 in the X and Y directions are small are widened. The regions in which the detection errors of the differences SX and SY between the output signals are small represents linear regions (first and second linear regions) in which the differences SX and SY between the output signals change substantially linearly with respect to the position changes of the reflection unit 25 in the X and Y directions. The difference SX between the output signals corresponds to the force (shearing force) F_{X} acting in the X direction, and the difference SY between the output signals corresponds to the force (shearing force) F_{Y} acting in the Y direction.

From the viewpoint of the above characteristics, the IC 11 operates as follows in a case where the distance between the center position of the reflection unit 25 and the base material 21 is larger than the specified value.

The IC 11 calculates a difference SX_{A1,A6} (=(S_{A1}−S_{A6})/(S_{A1}+S_{A6})) between the output signals from the output signals S_{A1} and S_{A6} of the pair of the first light receiving units 23A₁ and 23A₆. The IC 11 calculates the force F_{X} acting in the X direction on the basis of the calculated difference SX_{A1,A6} between the output signals and outputs the force F_{X} to the main CPU 12A.

The IC 11 calculates a difference SY_{B1,B6} (=(S_{B1}−S_{B6})/(S_{B1}+S_{B6})) between the output signals from the output signals S_{B1} and S_{B6} of the pair of the second light receiving units 23B₁, 23B₆. The IC 11 calculates the force F_{Y} acting in the Y direction on the basis of the calculated difference SY_{B1,B6} between the output signals, and outputs the force F_{Y} to the main CPU 12A.

(Detection of Forces F_{X} and F_{Y} Acting in X and Y Directions in a Case where Distance Between Reflection Unit 25 and Base Material 21 is Small)

As the distance between the center position of the reflection unit 25 and the base material 21 becomes smaller, the light distribution of the reflected light by the reflection unit 25 decreases. Therefore, as the distance between the center position of the reflection unit 25 and the base material 21 becomes smaller, regions in which the detection errors of the differences SX (=(S_{Am}−S_{An})/(S_{Am}+S_{An})) and SY (=(S_{Bm}−S_{Bn})/(S_{Bm}+S_{Bn})) between the output signals with respect to the position changes of the reflection unit 25 in the X and Y directions are small becomes narrower. The regions in which the detection errors of the differences SX and SY between the output signals are small represents linear regions (first and second linear regions) in which the differences SX and SY between the output signals change substantially linearly with respect to the position changes of the reflection unit 25 in the X and Y directions as described above. The difference SX between the output signals corresponds to the force F_{X} acting in the X direction, and the difference SY between the output signals corresponds to the force F_{Y} acting in the Y direction.

From the viewpoint of the above characteristics, the IC 11 operates as follows in a case where the distance between the center position of the reflection unit 25 and the base material 21 is smaller than the specified value.

The IC 11 calculates the force F_{X} acting in the X direction using the pair SAₘ, SAₙ of output signals that can minimize the detection error of the force FX among the pair SAₘ, SAₙ of output signals. In addition, the IC 11 calculates the force F_{Y} acting in the Y direction using the pair SBₘ, SBₙ of output signals that can minimize the detection error of the force F_{Y} among the pair SBₘ, SBₙ of output signals.

The pair SAₘ, SAₙ of the output signals used for the calculation of the force F_{X} is, for example, the pair SAₘ, SAₙ of the output signals output from the pair of first light receiving units 23Aₘ and 23Aₙ separated by a specified distance across the center of the light receiving unit group 23, that is, across the light source 22. Specifically, there are a pair SA₁, SA₄ of the output signals of the first light receiving units 23A₁ and 23A₄, a pair SA₂, SA₅ of the output signals of the first light receiving units 23A₂ and 23A₅, and a pair SA₃, SA₆ of the output signals of the first light receiving units 23A₃ and 23A₆.

The pair SBₘ, SBₙ of the output signals used for the calculation of the force F_{Y} is, for example, the pair SBₘ, SBₙ of the output signals output from the pair of the second light receiving units 23Bₘ and 23Bₙ separated by a specified distance across the center of the light receiving unit group 23, that is, across the light source 22. Specifically, there are a pair SB₁, SB₄ of the output signals of the second light receiving units 23B₁ and 23B₄, a pair SB₂, SB₅ of the output signals of the second light receiving units 23B₂ and 23B₅, and a pair SB₃, SB₆ of the output signals of the second light receiving units 23B₃ and 23B₆.

More specifically, the IC 11 operates as follows.

(Calculation of Center Positions X_{A1,A4}, X_{A2,A5}, and X_{A3,A6} of Reflection Unit 25)

The IC 11 calculates the center positions X_{A1,A4}, X_{A2,A5}, and X_{A3,A6} of the reflection unit 25 as follows.

### (Calculation of Center Position X_{A1,A4} of Reflection Unit 25)

The IC 11 calculates a difference SX_{A1,A4} (=(S_{A1}−S_{A4})/(S_{A1}+S_{A4})) between the output signals from the output signals S_{A1} and S_{A4} of the pair of the first light receiving units 23A₁ and 23A₄. The difference SX_{A1,A4} between the output signals is a value corresponding to the displacement amount of the center position of the reflection unit 25 in the X direction with reference to the central axis 20L. The IC 11 calculates the center position X_{A1,A4} of the reflection unit 25 on the basis of the calculated difference SX_{A1,A4} between the output signals.

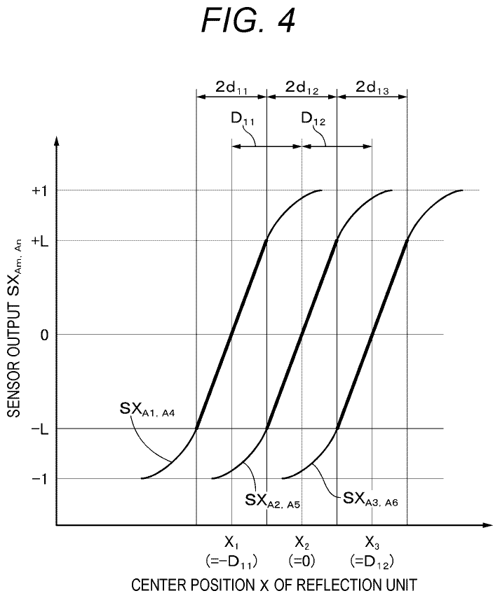

As illustrated in FIG. 4, in a case where the region of −L≤SX_{A1,A4}≤+L is a linear region, the center position X_{A1,A4} of the reflection unit 25 is obtained by the following Formula (1-1) using the difference SX_{A1,A4} (that is, the output signals S_{A1} and S_{A4} obtained from the pair of the first light receiving units 23A₁ and 23A₄) between the output signals.

$${X}_{A 1 , A 4} = - {D}_{11} + ( {d}_{11} / L ) \times {SX}_{A 1 , A 4} \qquad ( 1 - 1 )$$

where D₁₁ is the position of the midpoint between the pair of first light receiving units 23A₁ and 23A₄, and d₁₁ is (width of linear region of SX_{A1,A4} in X direction)/2.

Note that the linear region represents a linear region (first and second linear regions) in which the differences SX_{Am,An} and SY_{Bm,Bn} between the output signals change substantially linearly with respect to the position change of the reflection unit 25 in the X and Y directions.

### (Calculation of Center Position X_{A2,A5} of Reflection Unit 25)

The IC 11 calculates a difference SX_{A2,A5} (=(S_{A2}−S_{A5})/(S_{A2}+S_{A5})) between the output signals from the output signals S_{A2} and S_{A5} of the pair of the first light receiving units 23A₂, 23A₅. The difference SX_{A2,A5} between the output signals is a value corresponding to the displacement amount of the center position of the reflection unit 25 in the X direction with reference to the central axis 20L. The IC 11 calculates the center position X_{A2,A5} of the reflection unit 25 on the basis of the calculated difference SX_{A2,A5} between the output signals.

As illustrated in FIG. 4, in a case where the region of −L≤SX_{A2,A5}≤+L is a linear region, the center position X_{A2,A5} of the reflection unit 25 is obtained by the following Formula (1-2) using the difference SX_{A2,A5} (that is, the output signals S_{A2} and S_{A5} obtained from the pair of the first light receiving units 23A₂ and 23A₅) between the output signals.

$${X}_{A 2 , A 5} = ( {d}_{12} / L ) \times {SX}_{A 2 , A 5} \qquad ( 1 - 2 )$$

Here, d₁₂ is (width of linear region of SX_{A2,A5} in X direction)/2.

### (Calculation of Center Position X_{A3,A6} of Reflection Unit 25)

The IC 11 calculates a difference SX_{A3,A6} (=(S_{A3}−S_{A6})/(S_{A3}+S_{A6})) between the output signals from the output signals S_{A3} and S_{A6} of the pair of the first light receiving units 23A₃ and 23A₆. The difference SX_{A3,A6} between the output signals is a value corresponding to the displacement amount of the center position of the reflection unit 25 in the X direction with reference to the central axis 20L. The IC 11 calculates the center position X_{A3,A6} of the reflection unit 25 on the basis of the calculated difference SX_{A3,A6} between the output signals.

As illustrated in FIG. 4, in a case where the region of −L≤SX_{A3,A6}≤+L is a linear region, the center position X_{A3,A6} of the reflection unit 25 is obtained by the following Formula (1-3) using the difference SX_{A3,A6} (that is, the output signals S_{A3} and S_{A6} obtained from the pair of the first light receiving units 23A₃ and 23A₆) between the output signals.

$${X}_{A 3 , A 6} = {D}_{12} + ( {d}_{13} / L ) \times {SX}_{A 3 , A 6} \qquad ( 1 - 3 )$$

where D₁₂ is the position of the midpoint between the pair of first light receiving units 23A₃ and 23A₆, and d₁₃ is (width of linear region of SX_{A3,A6} in X direction)/2.

### (Calculation of Force F_{X} Acting in X Direction)

The IC 11 selects X_{Am,An} included in the linear region among X_{A1,A4}, X_{A2,A5}, and X_{A3,A6}. In a case where one X_{Am,An} is selected as X_{Am,An} included in the linear region, the IC 11 sets the X_{Am,An} as X_{Am,An} with the least error. In a case where two or more X_{Am,An} are selected as X_{Am,An} included in the linear region, the IC 11 sets X_{Am,An} closest to the center position of the linear region among the two or more X_{Am,An} as X_{Am,An} with the least error.

The IC 11 calculates the force F_{X} acting in the X direction using X_{Am,An} with the least error. More specifically, for example, the IC 11 calculates the difference (difference in sensor output value) SX_{Am,An} between the output signals from X_{Am,An} with the smallest error. Alternatively, the IC 11 selects the difference SX_{Am,An} between the output signals corresponding to X_{Am,An} with the least error from among the differences SX_{A1,A4}/SX_{A2,A5}, and SX_{A3,A6} between the output signals calculated in advance.

The IC 11 calculates the force F_{X} acting in the X direction on the basis of the calculated or selected difference SX_{Am,An} between the output signals, and outputs the force FX to the main CPU 12A.

(Calculation of Center Positions Y_{B1,B4}, Y_{B2,B5}, and Y_{B3,B6} of Reflection Unit 25)

The IC 11 calculates the center positions Y_{B1,B4}, Y_{B2,B5}, and Y_{B3,B6} of the reflection unit 25 as follows.

### (Calculation of Center Position Y_{B1,B4} of Reflection Unit 25)

The IC 11 calculates a difference SY_{B1,B4} (=(S_{B1}−S_{B4})/(S_{B1}+S_{B4})) between the output signals from the output signals S_{B1} and S_{B4} of the pair of the second light receiving units 23B₁ and 23B₄. The difference SY_{B1,B4} between the output signals is a value corresponding to a displacement amount of the center position of the reflection unit 25 in the Y direction with reference to the central axis 20L. The IC 11 calculates the center position Y_{B1,B4} of the reflection unit 25 on the basis of the calculated difference SY_{A1,A4} between the output signals.

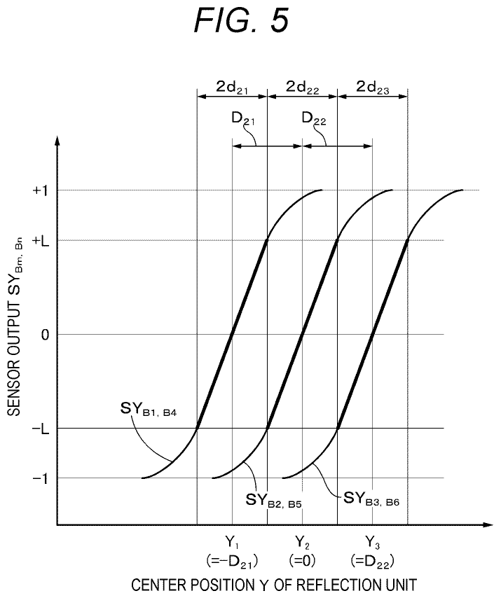

As illustrated in FIG. 5, in a case where the region of −L≤SY_{B1,B4}≤+L is a linear region, the center position Y_{B1,B4} of the reflection unit 25 is obtained by the following Formula (2-1) using the difference SY_{B1,B4} (that is, the output signals S_{B1} and S_{B4} obtained from the pair of the second light receiving units 23B₁ and 23B₄) between the output signals.

$${Y}_{B 1 , B 4} = - {D}_{21} + ( {d}_{21} / L ) \times {SY}_{B 1 , B 4} \qquad ( 2 - 1 )$$

where D₂₁ is the position of the midpoint between the pair of second light receiving units 23B₁ and 23B₄, and d₂₁ is (width of linear region of SY_{B1,B4} in Y direction)/2.

### (Calculation of Center Position Y_{B2,B5} of Reflection Unit 25)

The IC 11 calculates a difference SY_{B2,B5} (=(S_{B2}−S_{B5})/(S_{B2}+S_{B5})) between the output signals from the output signals S_{B2} and S_{B5} of the pair of the second light receiving units 23B₂ and 23B₅. The difference SY_{B2,B5} between the output signals is a value corresponding to the displacement amount of the center position of the reflection unit 25 in the Y direction with reference to the central axis 20L. The IC 11 calculates the center position Y_{B2,B5} of the reflection unit 25 on the basis of the calculated difference SY_{B2,B5} between the output signals.

As illustrated in FIG. 5, in a case where the region of −L≤SY_{B2,B5}≤+L is a linear region, the center position Y_{B2,B5} of the reflection unit 25 is obtained by the following Formula (2-2) using the difference SY_{B2,B5} (that is, the output signals S_{B2} and S_{B5} obtained from the pair of the second light receiving units 23B₂ and 23B₅) between the output signals.

$${Y}_{B 2 , B 5} = ( {d}_{22} / L ) \times {SY}_{B 2 , B 5} \qquad ( 2 - 2 )$$

Here, d₂₂ is (width of linear region of SY_{B2,B5} in Y direction)/2.

### (Calculation of Center Position Y_{B3,B6} of Reflection Unit 25)

The IC 11 calculates a difference SY_{B3,B6} (=(S_{B3}−S_{B6})/(S_{B3}+S_{B6})) between the output signals from the output signals S_{B3}, S_{B6} of the pair of the second light receiving units 23B₃, 23B₆. The difference SY_{B3,B6} between the output signals is a value corresponding to the displacement amount of the center position of the reflection unit 25 in the Y direction with reference to the central axis 20L. The IC 11 calculates the center position Y_{B3,B6} of the reflection unit 25 on the basis of the calculated difference SY_{B3,B6} between the output signals.

As illustrated in FIG. 5, in a case where the region of −L≤SY_{B3,B6}≤+L is a linear region, the center position Y_{B3,B6} of the reflection unit 25 is obtained by the following Formula (2-3) using the difference SY_{B3,B6} (that is, the output signals S_{B3} and S_{B6} obtained from the pair of the second light receiving units 23B₃ and 23B₆) between the output signals.

$${Y}_{B 3 , B 6} = {D}_{22} + ( {d}_{23} / L ) \times {SY}_{B 3 , B6} \qquad ( 2 - 3 )$$

where D₂₂ is the position of the midpoint between the pair of second light receiving units 23B₃ and 23B₆, and d₂₃ is (width of linear region of SY_{B2,B5} in Y direction)/2.

### (Calculation of Force F_{Y} Acting in Y Direction)

The IC 11 selects Y_{Bm,Bn} included in the linear region from among Y_{B1,B4}, Y_{B2,B5}, and Y_{B3,B6}. In a case where one Y_{Bm,Bn} is selected as Y_{Bm,Bn} included in the linear region, the IC 11 sets the Y_{Bm,Bn} as Y_{Bm,Bn} with the least error. In a case where two or more Y_{Bm,Bn} are selected as Y_{Bm,Bn} included in the linear region, the IC 11 sets Y_{Bm,Bn} closest to the center position of the linear region among the two or more Y_{Bm,Bn} as Y_{Bm,Bn} with the least error.

The IC 11 calculates the force F_{Y} acting in the Y direction using Y_{Bm,Bn} with the least error. More specifically, for example, the IC 11 calculates the difference (difference in sensor output value) SY_{Bm,Bn} between the output signals from Y_{Bm,Bn} with the smallest error. Alternatively, the IC 11 selects the difference SY_{Bm,Bn} between the output signals corresponding to Y_{Bm,Bn} with the least error from among differences SY_{B1,B4}, SY_{B2,B5}, and SY_{B3,B6} between the output signals calculated in advance.

The IC 11 calculates the force F_{Y} acting in the Y direction on the basis of the difference SY_{Bm,Bn} between the calculated or selected output signals, and outputs the force F_{Y} to the main CPU 12A.

[Detection Principle of Forces F_{X}, F_{Y}, F_{Z}]

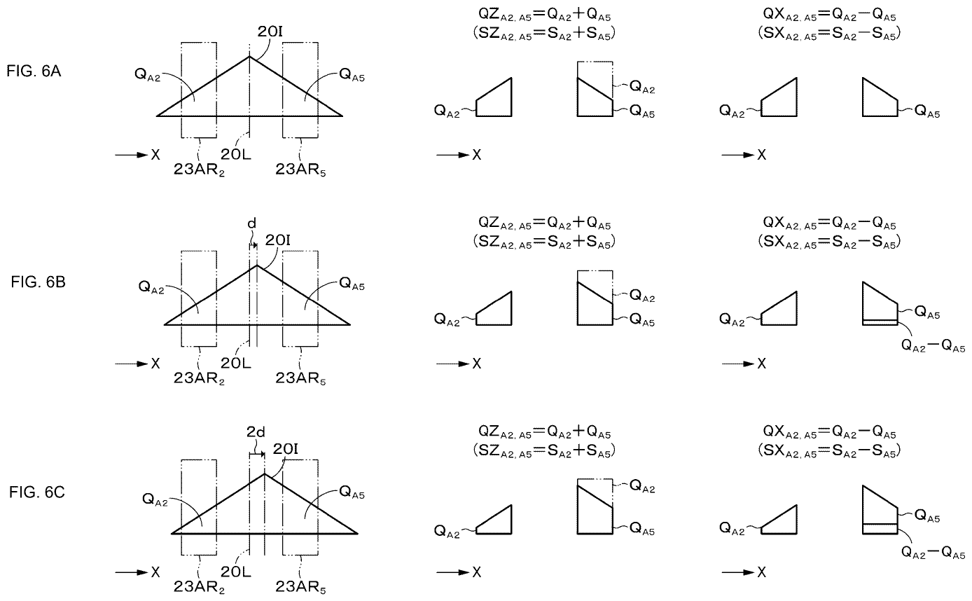

Hereinafter, with reference to FIGS. 6A, 6B, and 6C, the detection principle of the force F_{Z} acting in the ±Z direction and the force F_{X} acting in the X direction will be described by taking, as an example, a case where there is positional displacement only in the ±X direction among the ±X direction, the ±Y direction, and the ±Z direction. In FIGS. 6A, 6B, and 6C, the displacement amounts ΔX=d and 2d of the reflection unit 25 represent the displacement amount of the geometric center of the reflection unit 25 in the ±X direction. Regions 23AR₂ and 23AR₅ in FIGS. 6A, 6B, and 6C represent regions corresponding to the first light receiving units 23A₂ and 23A₅ in a light distribution 20I.

When light of a light amount Q_{A2} is received by the first light receiving unit 23A₂, the first light receiving unit 23A₂ outputs an output signal S_{A2} corresponding to the light amount Q_{A2}. When light of a light amount Q_{A5} is received by the first light receiving unit 23A₅, the first light receiving unit 23A₅ outputs an output signal S_{A2} corresponding to the light amount Q_{A5}.

Before and after the movement of the reflection unit 25, the sum QZ_{A2,A5} (=QA2+Q_{A5}) of the light amount Q_{A2} received by the first light receiving unit 23A₂ and the light amount Q_{A5} received by the first light receiving unit 23A₅ is constant regardless of the displacement amount ΔX (for example, ΔX=0, ΔX=d, and X=2d) at the center position of the reflection unit 25. The sum QZ_{A2,A5} of the light amounts corresponds to the amount of displacement of the center position of the reflection unit 25 in the Z direction. Accordingly, the IC 11 can calculate the force F_{Z} acting in the Z direction on the basis of the sum SZ_{A2,A5} (=S_{A2}+S_{A5}) of the output signal S_{A2} of the first light receiving unit 23A₂ and the output signal S_{A5} of the first light receiving unit 23A₅.

Before and after the movement of the reflection unit 25, the difference QX_{A2,A5} (=Q_{A2}−Q_{A5}) in light amount between the light amount Q_{A2} received by the first light receiving unit 23A₂ and the light amount Q_{A5} received by the first light receiving unit 23A₅ changes linearly (linear) depending on the displacement amount ΔX (for example, ΔX=0, ΔX=d, and ΔX=2d) at the center position of the reflection unit 25. The difference QX_{A2,A5} between the light amounts corresponds to the displacement amount of the center position of the reflection unit 25 in the +X direction. As a result, the IC 11 can calculate the force F_{X} acting in the +X direction on the basis of the difference SX_{A2,A5} (=SX_{A2}−SX_{A5}) between the output signal S_{A2} of the first light receiving unit 23A₂ and the output signal S_{A5} of the first light receiving unit 23A₅.

### [Principle of Dynamic Lens Enlargement]

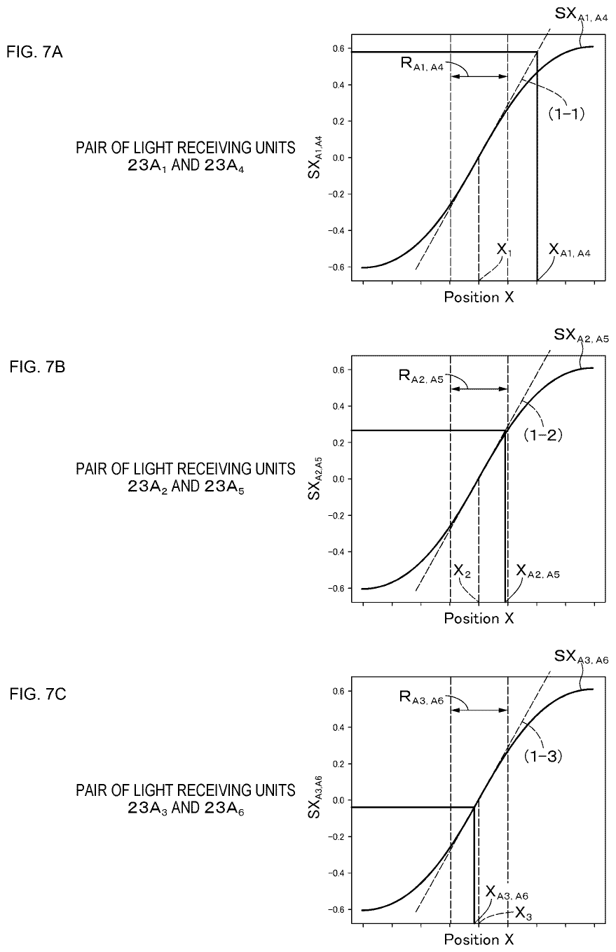

Hereinafter, the principle of dynamic lens enlargement of the sensor module 10 will be described with reference to FIGS. 7A to 7C, FIGS. 8A to 8D, FIGS. 9A to 9C, and FIGS. 10A to 10D.

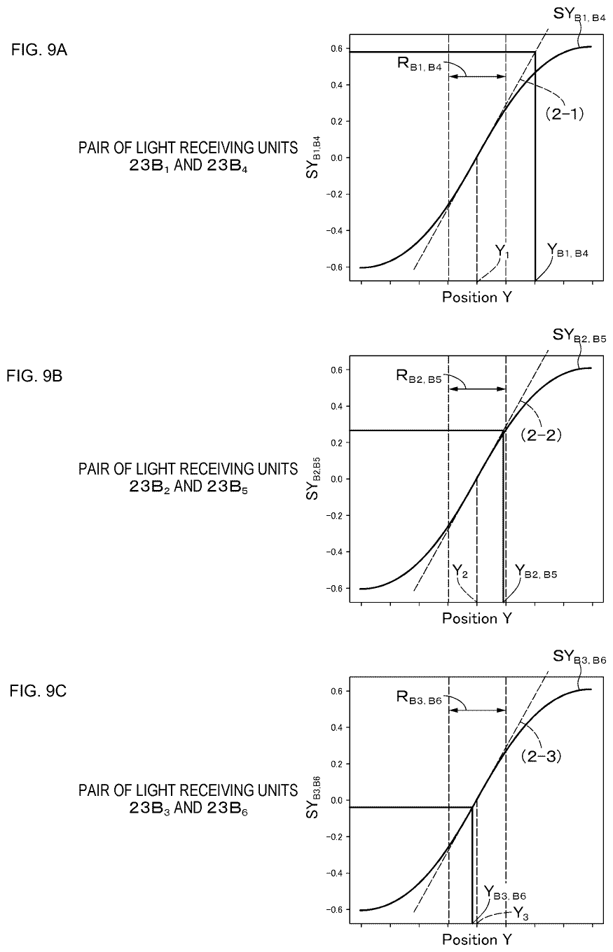

In FIGS. 6A, 6B, and 6C, an example in which the light distribution 201 has a conical shape and the gradient of the light distribution 201 linearly changes has been described. However, as illustrated in FIG. 15, the actual light distribution is different from the conical shape, and there are a region in which the gradient of the light distribution 201 linearly changes and a region in which the gradient of the light distribution 201 does not linearly change located inside and outside the region. Therefore, as illustrated in FIGS. 7A, 7B, and 7C, there are a region in which the difference SX_{Am,An}(=(SX_{Am}−SX_{An})/(SX_{Am}+X_{An})) between the output signals linearly changes and a region in which the difference SX_{Am,An} between the output signals does not linearly change. Similarly, regarding the difference SY_{Bm,Bn} (=(SY_{Bm}−SY_{Bn})/(SY_{Bm}+SY_{Bn})) between the output signals, as illustrated in FIGS. 9A, 9B, and 9C, there are a region in which the difference SY_{Bm,Bn} between the output signals linearly changes and a region in which the difference SB_{Bm,Bn} between the output signals does not linearly change.

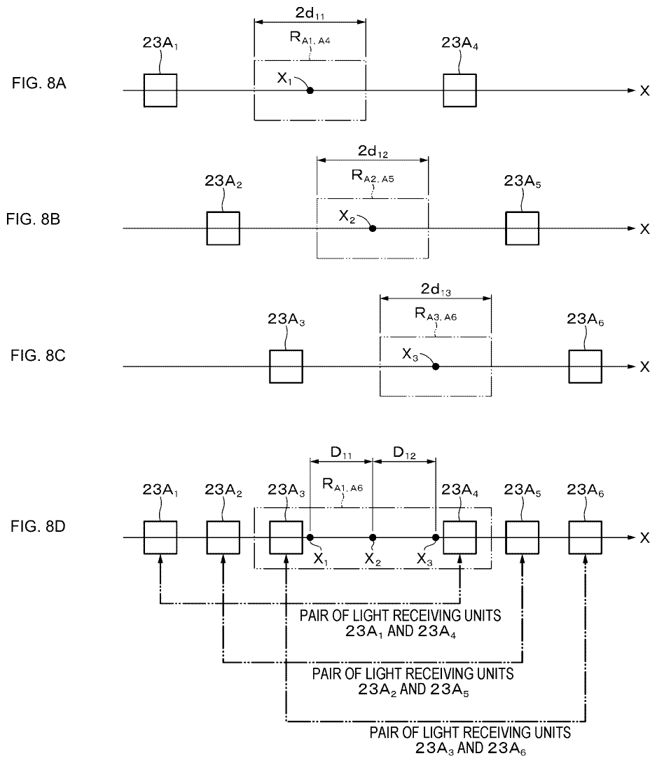

In a case where the IC 11 detects the center position X of the reflection unit 25 using only the difference SX_{A1,A4} (=(S_{A1}−S_{A4})/(S_{A1}+S_{A4})) between the output signals of the pair of the first light receiving units 23A₁ and 23A₄, as illustrated in FIGS. 7A and 8A, only the region R_{A1,A4} has a small detection error of the position X (that is, a linear region in which the value of SX_{A1,A4} substantially linearly changes).

In a case where the IC 11 detects the center position X of the reflection unit 25 using only the difference SX_{A2,A5} (=(S_{A2}−S_{A5})/(S_{A2}+S_{A5})) between the output signals of the pair of the first light receiving units 23A₂ and 23A₆, as illustrated in FIGS. 7B and 8B, only the region R_{A2,A5} has a small detection error of the position X (that is, a linear region in which the value of SX_{A2,A5} substantially linearly changes).

In a case where the IC 11 detects the center position X of the reflection unit 25 using only the difference SX_{A3,A6} (=(S_{A3}−S_{A6})/(S_{A3}+S_{A6})) between the output signals of the pair of the first light receiving units 23A₃ and 23A₆, as illustrated in FIGS. 7C and 8B, only the region R_{A3,A6} has a small detection error of the position X (that is, a linear region in which the value of SX_{A3,A6} substantially linearly changes).

In a case where the IC 11 detects the center position X of the reflection unit 25 by using the difference SX_{A1,A4} between the output signals obtained by the pair of the first light receiving units 23A₁ and 23A₄, the difference SX_{A2,A5} between the output signals obtained by the pair of the first light receiving units 23A₂ and 23A₅, and the difference SX_{A3,A6} between the output signals obtained by the pair of the first light receiving units 23A₃ and 23A₆, as illustrated in FIG. 8D, a region with a small detection error of the position X is the region R_{A1,A6}. The region R_{A1,A6} corresponds to a region in which the region R_{A1,A4}, the region R_{A2,A5}, and the region R_{A3,A6} are integrated. Therefore, in a case where the IC 11 detects the center position X of the reflection unit 25 using the difference SX_{A1,A4} between the output signals, the difference SX_{A2,A5} between the output signals, and the differences SX_{A3,A6} between the output signals as described above, the dynamic lens in the ±X direction can be enlarged.

Specific examples of the widths (widths in the X-axis direction) of the region R_{A1,A4}, the region R_{A2,A5}, the region R_{A3,A6}, and the regions R_{A1,A6} are shown below. The widths (widths in the X-axis direction) of the region R_{A1,A4}, the region R_{A2,A5}/and the regions R_{A3,A6} are, for example, 0.2 mm. The pair of first light receiving units 23A₁ and 23A₄ are arranged to be shifted from the pair of first light receiving units 23A₂ and 23A₅ by, for example, 0.1 mm in the −X direction. The pair of first light receiving units 23A₃ and 23A₆ are arranged to be shifted from the pair of first light receiving units 23A₂ and 23A₅ by, for example, 0.1 mm in the ±X direction. The width (width in the X-axis direction) of the region R_{A1,A6} in which the region R_{A1,A4}, the region R_{A2,A5}, and the region R_{A3,A6} are integrated is, for example, 0.4 mm.

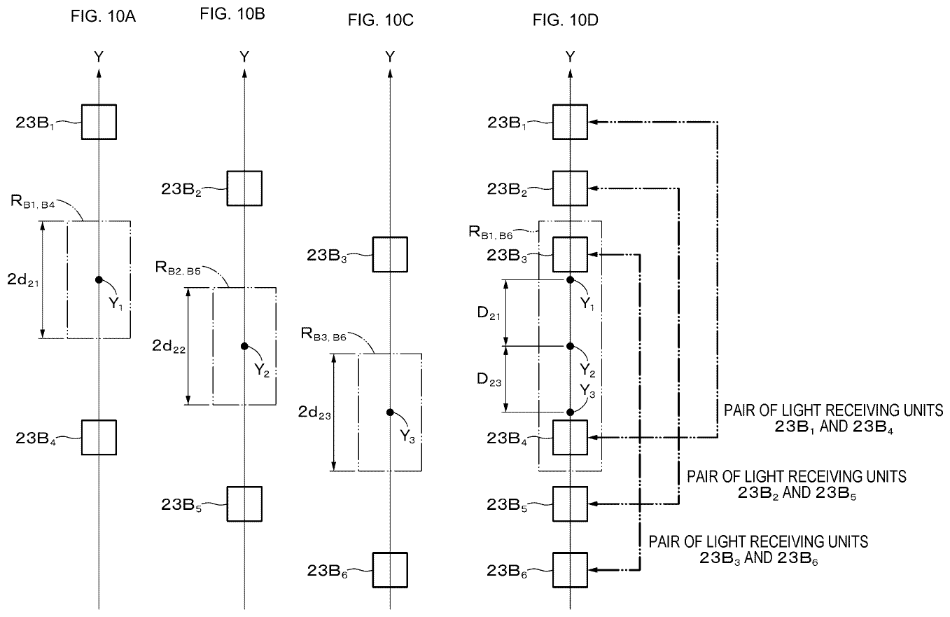

In a case where the IC 11 detects the center position Y of the reflection unit 25 using only the difference SY_{B1,B4} (=(S_{B1}−S_{B4})/(S_{B1}+S_{B4})) between the output signals of the pair of the second light receiving units 23B₁ and 23B₄, as illustrated in FIGS. 9A and 10A, only the region R_{B1,B4} has a small detection error of the position Y (that is, a linear region in which the value of SY_{B1,B4} substantially linearly changes).

In a case where the IC 11 detects the center position Y of the reflection unit 25 using only the difference SY_{B2,B5} (=(S_{B2}−S_{B5})/(S_{B2}+S_{B5})) between the output signals of the pair of the second light receiving units 23B₂ and 23B₅, as illustrated in FIGS. 9B and 10B, only the region R_{B2,B5} has a small detection error of the position Y (that is, a linear region in which the value of SY_{B2,B5} substantially linearly changes).

In a case where the IC 11 detects the center position Y of the reflection unit 25 using only the difference SY_{B3,B6} (=(S_{B3}−S_{B6})/(S_{B3}+S_{B6})) between the output signals of the pair of the second light receiving units 23B₃ and 23B₆, as illustrated in FIGS. 9C and 10C, only the region R_{B3,B6} has a small detection error of the position Y (that is, a linear region in which the value of SY_{B3,B6} substantially linearly changes).

In a case where the IC 11 detects the center position Y of the reflection unit 25 using the difference SY_{A1,A4} between the output signals obtained by the pair of second light receiving units 23B₁ and 23B₄, the difference SY_{B2,B5} between the output signals obtained by the pair of second light receiving units 23B₂ and 23B₅, and the difference SY_{B3,B6} between the output signals obtained by the pair of second light receiving units 23B₃ and 23B₆, as illustrated in FIG. 10D, a region with a small detection error of the position Y is the region R_{B1,B6}. The region R_{B1,B6} corresponds to a region in which the region R_{B1,B4}, the region R_{B2,B5}, and the region R_{B3,B6} are integrated. Therefore, in a case where the IC 11 detects the center position Y of the reflection unit 25 using the difference SY_{B1,B4} between the output signals, the difference SY_{B2,B5} between the output signals, and the difference SY_{B3,B6} between the output signals as described above, the dynamic lens in the +Y direction can be enlarged.

Specific examples of the widths (widths in the Y-axis direction) of the region R_{B1,B4}, the region R_{B2,B5}, the region R_{B3,B6}, and the region R_{B1,B6} are shown below. The widths (widths in the Y-axis direction) of the region R_{B1,B4}, the region R_{B2,B5}/and the region R_{B3,B6} are, for example, 0.2 mm. The pair of second light receiving units 23B₁ and 23B₄ are arranged to be shifted from the pair of second light receiving units 23B₂ and 23B₅ by, for example, 0.1 mm in the +Y direction. The pair of second light receiving units 23B₃ and 23B₆ are arranged to be shifted from the pair of second light receiving units 23B₂ and 23B₅ by, for example, 0.1 mm in the −Y direction. The width (width in the Y-axis direction) of the region R_{B1,B6} in which the region R_{B1,B4}, the region R_{B2,B5}, and the region R_{B3,B6} are integrated is, for example, 0.6 mm.

### [Operation of Sensor Module 10]

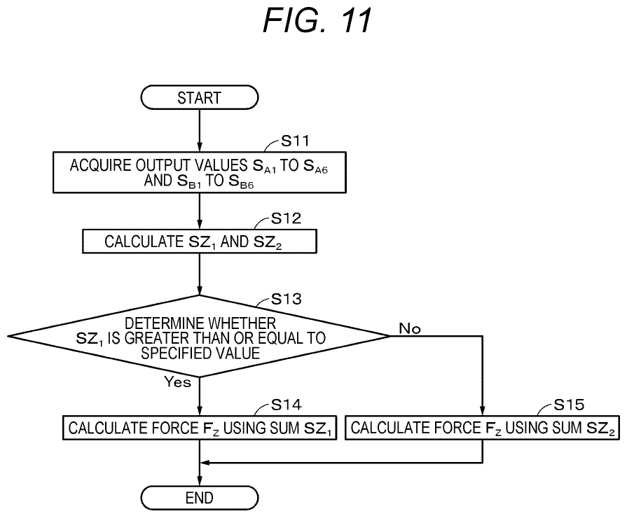

Hereinafter, an example of the detection operation of the force F_{Z} by the sensor module 10 will be described with reference to FIG. 11.

First, in step S11, the IC 11 scans the first light receiving units 23A₁ to 23A₆ and the second light receiving units 23B₁ to 23B₆, and obtains the output signals S_{A1} to S_{A6} from the first light receiving units 23A₁ to 23A₆ and the output signals S_{B1} to S_{B6} from the second light receiving units 23B₁ to 23B₆. Next, in step S12, the IC 11 calculates the sum S_{A1} (=S_{A1}+S_{A6}+S_{B1}+S_{B6}) of the output signals from the output signals S_{A1} and S_{A6} of the pair of the first light receiving units 23A₁ and 23A₆ and the output signals S_{B1} and S_{B6} of the pair of the second light receiving units 23B₁ and 23B₆. Further, the IC 11 calculates the sum SZ₂ (=S_{A2}+S_{A5}+S_{B2}+S_{B5}) of the output signals from the output signals S_{A2} and S_{A5} of the pair of the first light receiving units 23A₂ and 23A₅ and the output signals S_{B2} and S_{B5} of the pair of the second light receiving units 23B₂ and 23B₅.

Next, in step S13, the IC 11 determines whether the calculated sum SZ of the output signals is greater than or equal to the specified value. In a case where it is determined in step S13 that the sum SZ₁ of the output signals is greater than or equal to the specified value, the IC 11 calculates the force F_{Z} on the basis of the sum SZ₁ of the output signals in step S14. In a case where it is determined in step S13 that the sum SZ₁ of the output signals is not greater than or equal to the specified value, the IC 11 calculates the force F_{Z} on the basis of the sum SZ₂ of the output signals in step S15, and outputs the force F_{Z} to the main CPU12A.

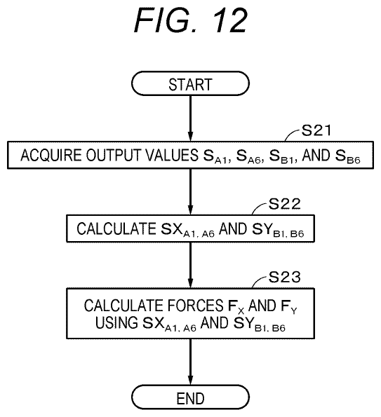

Hereinafter, an example of first detection operation of the forces F_{X} and F_{Y} by the sensor module 10 will be described with reference to FIG. 12. The first detection operation is performed, for example, in a case where it is determined in step S13 of FIG. 11 that the sum SZ₁ of the output signals is greater than or equal to the specified value.

First, in step S21, the IC 11 scans the first light receiving units 23A₁ and 23A₆ and the second light receiving units 23B₁ and 23B₆, and obtains the output signals S_{A1} and S_{A6} from the first light receiving units 23A₁ and 23A₆ and the output signals S_{B1} and S_{B6} from the second light receiving units 23B₁ and 23B₆.

Next, in step S22, the IC 11 calculates the difference SX_{A1,A6} (=(S_{A1}−S_{A6})/(S_{A1}+S_{A6})) between the output signals and the difference SY_{B1,B6} (=(S_{B1}−S_{B6})/(S_{B1}+S_{B6})) between the output signals using the output signals S_{A1} and S_{A6} and the output signals S_{B1} and S_{B6} obtained in step S21. The IC 11 may calculate the difference SX_{A1,A6} between the output signals and the difference SX_{B1,B6} between the output signals using the output signals S_{A1} and S_{A6} and the output signals S_{B1} and S_{B6} obtained in step S11 of FIG. 11. In this case, the processing of step S21 may be omitted.

Next, in step S23, the IC 11 calculates the force F_{X} on the basis of the difference SX_{A1,A6} between the output signals, and calculates the force F_{Y} based on the difference SY_{B1,B6} between the output signals. The IC 11 outputs the calculated force F_{X} and force F_{Y} to the main CPU12A.

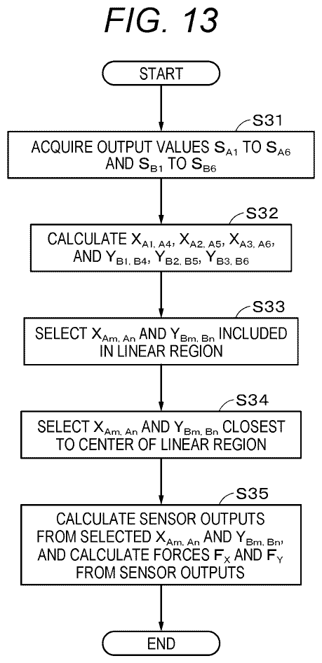

Hereinafter, an example of second detection operation of the forces F_{X} and F_{Y} by the sensor module 10 will be described with reference to FIG. 13. The second detection operation is performed, for example, in a case where it is determined in step S13 of FIG. 11 that the sum SZ₁ of the output signals is not greater than or equal to the specified value.

First, in step S31, the IC 11 scans the first light receiving unit 23A₁ to 23A₆ and the second light receiving unit 23B₁ to 23B₆, and obtains the output signals S_{A1} to S_{A6} from the first light receiving unit 23A₁ to 23A₆ and the output signals S_{B1} to S_{B6} from the second light receiving unit 23B₁ to 23B₆.

Next, in step S32, the IC 11 calculates the center positions X_{A1,A4}, X_{A2,A5}, X_{A3,A6}, Y_{B1,B4}, Y_{B2,B5}, and Y_{B3,B6} of the reflection unit 25 using the output signals S_{A1} to S_{A6} and the output signals S_{B1} to S_{B6} obtained in step S31. The IC 11 may calculate the center positions X_{A1,A4}, X_{A2,A5}, X_{A3,A6}, Y_{B1,B4}, Y_{B2,B5}, and Y_{B3,B6} of the reflection unit 25 using the output signals S_{A1} to S_{A6} and the output signals S_{B1} to S_{B6} obtained in step S11 of FIG. 11. In this case, the processing of step S31 may be omitted.

Next, in step S33, the IC 11 determines whether or not the calculated center positions X_{A1,A4}, X_{A2,A5}, and X_{A3,A6} of the reflection unit 25 are included in the linear regions R_{A1,A4}/R_{A2,A5}, and R_{A3,A6} (see FIGS. 7A, 7B, and 7C), respectively, and selects X_{Am,An} included in the linear region Ram, An. Further, the IC 11 determines whether or not Y_{B1,B4}, Y_{B2,B5}, and Y_{B3,B6} are included in the linear regions R_{B1,B4}, R_{B2,B5}, and R_{B3,B6} (see FIGS. 9A, 9B, and 9C), respectively, and selects X_{Bm,Bn} included in the linear region R_{Bm,Bn}.

Next, in step S34, the IC 11 selects X_{Am,An} closest to the center position of the linear region Ram, An among the X_{Am,An} selected in step S33 (see FIGS. 7A, 7B, 7C, 8A, 8B, 8C, and 8D). In FIGS. 7A, 7B, 7C, 8A, 8B, 8C, and 8D, X₁, X₂, and X₃ represent the center positions of the linear regions R_{A1,A4}, R_{A2,A5}, and R_{A3,A6}, respectively. In a case where there is one X_{Am,An} selected in step S33, the IC 11 may not perform the processing. Further, in step S34, the IC 11 selects Y_{Bm,Bn} closest to the center position of the linear region R_{Bm,Bn} among Y_{Bm,Bn} selected in step S33 (see FIGS. 9A, 9B, 9C, 10A, 10B, 10 C, and 10D). In FIGS. 9A, 9B, 9C, 10A, 10B, 10C, and 10D, Y₁, Y₂, and Y³ represent the center positions of the linear regions R_{B1,B4}, R_{B2,B5}, and R_{B3,B6}, respectively. In a case where there is one Y_{Bm,Bn} selected in step S33, the IC 11 may not perform the processing.

Next, in step S35, the IC 11 calculates differences between the output signals (differences between the sensor output value) SX_{Am,An} and SY_{Am,An} from X_{Am,An} and Y_{Bm,Bn} selected in step S34. The IC 11 calculates the forces F_{X} and F_{Y} acting in the X and Y directions based on the calculated differences SX_{Am,An} and SY_{Am,An} between the output signals, and outputs the forces F_{X} and F_{Y} to the main CPU 12A.

### [Simulation]

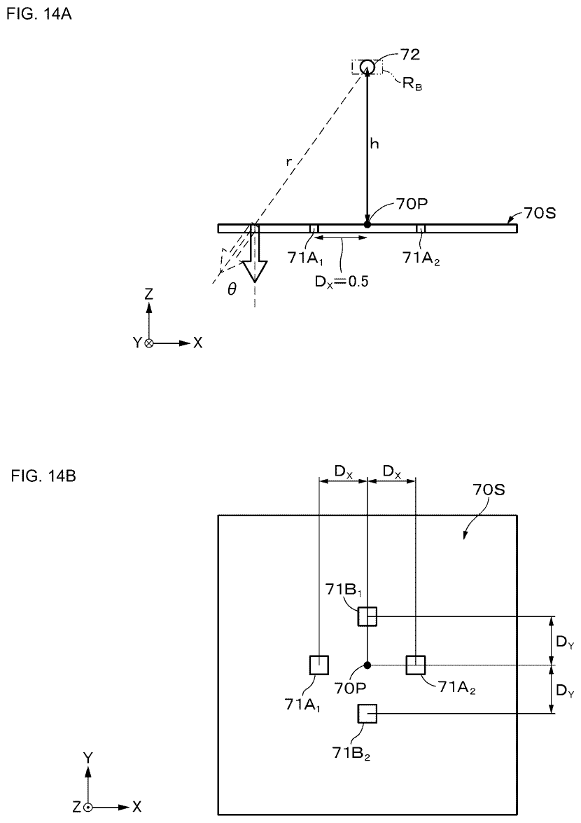

In simulations 1 and 2 shown below, models shown in FIGS. 14A and 14B were used as models of optical simulation. A point light source 72 corresponds to the reflection unit 25 of the sensor 20 in one embodiment. An irradiation surface 70S corresponds to the first surface (the arrangement surface of the light receiving unit group 23) of the base material 21 in one embodiment. First light receiving units 71A₁ and 71A₂ correspond to the first light receiving units 23A₂ and 23A₅ in one embodiment. Second light receiving units 71B₁ and 71B₂ correspond to the second light receiving units 23B₂ and 23B₅ in one embodiment.

In FIGS. 14A and 14B, the height h with respect to the irradiation surface 70S, a distance Dx between a center position 70P of the irradiation surface 70S and the center positions of the first light receiving units 71A₁ and 71A₂, and a distance Dy between the center position 70P of the irradiation surface 70S and the center positions of the second light receiving units 71B₁ and 71B₂ are as follows. However, the center position 70P was set immediately below the point light source 72.
Height h: 1.0
Distance Dx: 0.5
Distance Dy: 0.5

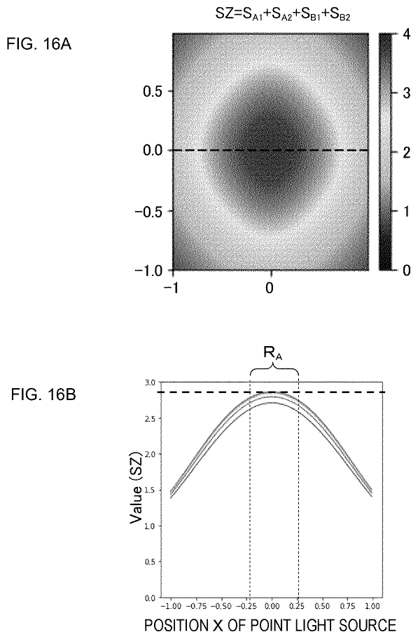

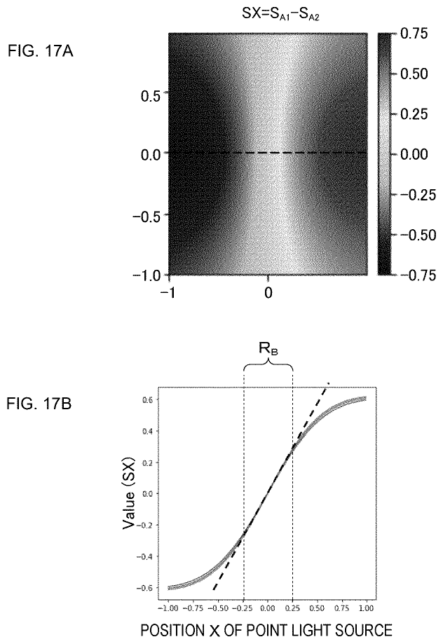

The distance Dx and the distance Dy are described in a ratio with the height h (h=1.0) as a reference. Similarly, the positions X and Y in FIG. 15 and the position X of the point light source in FIGS. 16B and 17B are also described in a ratio with the height h as a reference (h=1.0).

### (Simulation 1)

The illuminance distribution of the irradiation surface 70S in a state where the point light source 72 is stopped immediately above the center position 70P of the irradiation surface 70S was obtained by optical simulation. The results are shown in FIG. 15.

### (Simulation 2)

The sum SZ of the output signals, the difference SX_{A1,A2} between the output signals, and the difference SY_{B1,B2} between the output signals when the point light source 72 is moved in the +X direction and the +Y direction were obtained by optical simulation. However, the height h of the point light source 72 was maintained at a constant value of h=1.0.

The sum SZ of the output signals is a sum (S_{A1}+S_{A2}+S_{B1}+S_{B2}) of the output signals S_{A1} and S_{A2} of the first light receiving units 71A₁ and 71A₂ and the output signals S_{B1} and S_{B2} of the second light receiving units 71B₁ and 71B₂. The difference SX_{A1,A2} between the output signals is a difference (S_{A1}−S_{A2}) between the output signals S_{A1} and S_{A2} of the first light receiving units 71A₁ and 71A₂. The difference SY_{B1,B2} between the output signals is a difference (S_{B1}−S_{B2}) between the output signals S_{B1} and S_{B2} of the second light receiving units 71B₁ and 71B₂.

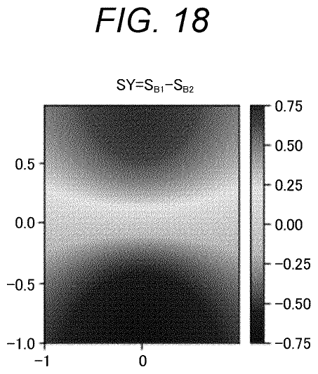

The results of the above optical simulation are shown in FIGS. 16A, 16B, 17A, 17B, and 18. A specified region R_{B} with a small detection error of the force (shear force) F_{X} is illustrated in FIG. 14A.

The sum SZ of the output signals is a substantially constant value in a specified region R_{A}, but changes outside the region of the specified region R_{A}. Therefore, the detection error of the force (pressing force) F_{Z} corresponding to the sum SZ of the output signals is small in the specified region R_{A}, but the error is large outside the region of the specified region R_{A}.

The difference SX_{A1,A2} between the output signals changes substantially linearly (substantially linear) in the specified region R_{B}, but does not change substantially linearly (substantially linear) outside the region of the specified region R_{B}. Therefore, the detection error of the force (shearing force) F_{X} corresponding to the difference SX_{A1,A2} between the output signals is small in the specified region R_{A} (that is, in a case where the deformation of the sensor in the X direction is small), but is large outside the region of the specified region R_{A} (that is, in a case where the deformation of the sensor in the X direction is large). Therefore, the dynamic range of the force (shear force) F_{X} acting in the X direction is limited.

In addition, the amount of change in the difference SX_{A1,A2} between the output signals outside the region of the specified region R_{A} is smaller than the amount of change in the difference SX_{A1,A2} between the output signals in the specified region R_{A}. Therefore, the sensitivity of the force (shearing force) F_{X} outside the region of the specified region R_{A} (that is, in a case where the deformation of the sensor in the X direction is large) is lower than the sensitivity of the force (shearing force) F_{X} in the specified region R_{A} (that is, in a case where the deformation of the sensor in the X direction is small).

The difference SY_{B1,B2} between the output signals has a tendency similar to the difference SX_{A1,A2} between the output signals.

### [Operations and Effects]

In the sensor module 10 according to one embodiment, the light emitted upward from the light source 22 is reflected by the reflection unit 25, and is then incident on the first light receiving units 23A₁ to 23A₆ and the second light receiving units 23B₁ to 23B₆. When a force acts on the dome-shaped curved surface of the sensor 20, the elastic body 24 is deformed, and the center position of the reflection unit 25 is displaced in at least one of the ±X direction, the ±Y direction, and the ±Z direction. The orientation distribution of the reflected light of the reflection unit 25 changes with the displacement of the center position of the reflection unit 25. The amount of light received by each of the first light receiving units 23A₁ to 23A₆ and the second light receiving units 23B₁ to 23B₆ changes according to the change in the orientation distribution, and the output signals SA₁ to SA₆ and SB₁ to SB₆ from the first light receiving units 23A₁ to 23A₆ and the second light receiving units 23B₁ to 23B₆ change. The IC can detect the forces F_{X}, F_{Y}, and F_{Z} acting on the sensor 20 based on the output signals SA₁ to SA₆ and SB₁ to SB₆.

In the sensor module 10 according to one embodiment, the sensor 20 includes the first light receiving units 23A₁ to 23A₆ arranged in the X direction (first direction) and the second light receiving units 23B₁ to 23B₆ arranged in the Y direction (second direction) orthogonal to the X direction. As a result, as compared with the sensor including one pair of the first light receiving units 23A₂ and 23A₅ arranged in the X direction and one pair of the second light receiving units 23B₂ and 23B₅ arranged in the Y direction, a region (linear region) in which the detection errors of the X position and the Y position can be reduced can be widened (see the region R_{A2,A5} in FIG. 8B, the region R_{A1,A6} in FIG. 8D, the region R_{B2,B5} in FIG. 10B, and the region R_{B1,B6} in FIG. 10D). Therefore, a wide dynamic range can be obtained and high sensitivity can be obtained with respect to the forces F_{X} and F_{Y} (that is, displacement of the reflection unit 25 in the ±X direction and the ±Y direction) acting in the ±X direction and the ±Y direction.

In addition, as compared with the sensor including one pair of the first light receiving units 23A₂ and 23A₅ arranged in the X direction and one pair of the second light receiving units 23B₂ and 23B₅ arranged in the Y direction, a region (linear region) in which the detection errors of the Z position can be reduced can be widened. Therefore, a wide dynamic range can be obtained and high sensitivity can be obtained with respect to the force F_{Z} acting in the −Z direction (that is, the displacement of the reflection unit 25 in the −Z direction).

### 2 Modification

### [Modification of Sensor]

In one embodiment, an example in which the sensor module 10 includes the sensor 20 has been described, but the sensor module 10 may include any one of the following sensors 30A to 30J and 20K of Modification 1 to 11 instead of the sensor 20.

### <Modification 1>

### [Configuration of Sensor 30A]

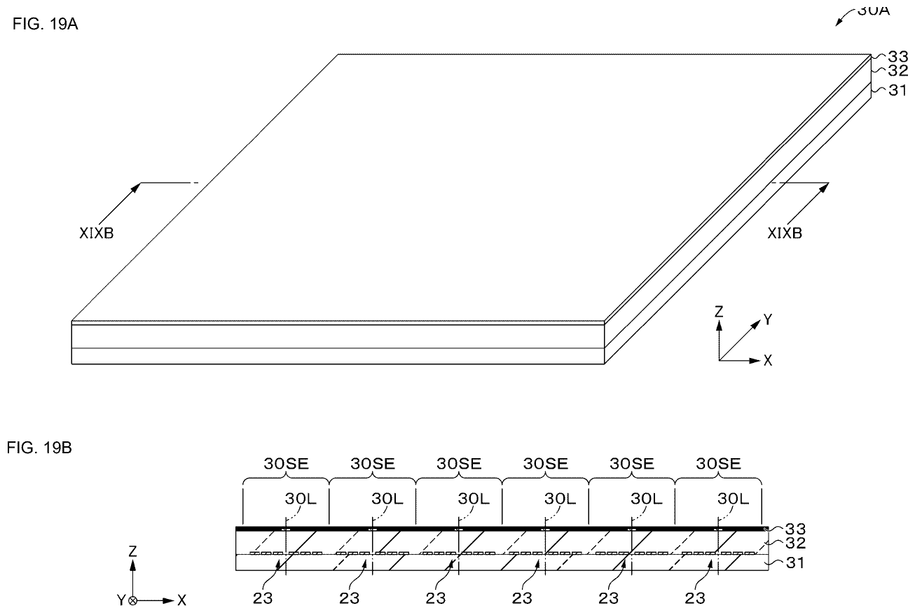

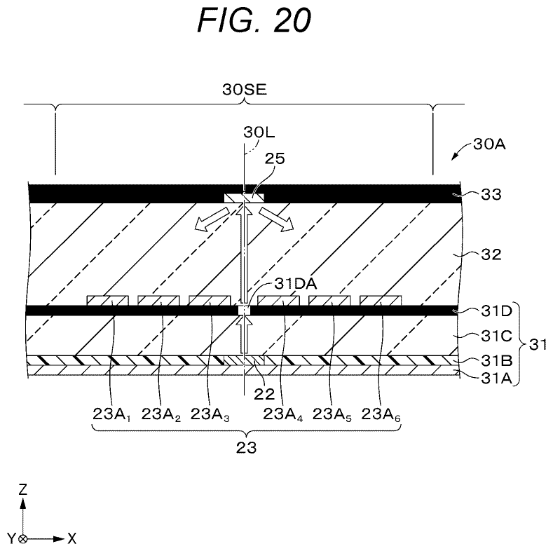

FIG. 19A is a plan view illustrating an example of an external appearance of the sensor 30A of Modification 1. FIG. 19B is a cross-sectional view taken along line XIXB-XIXB in FIG. 19A. FIG. 20 is an enlarged cross-sectional view of a part of FIG. 19B. The sensor 30A is an optical triaxial force sensor. The sensor 30A has a planar structure. The sensor 30A may have rigidity or flexibility.

The sensor 30A has, for example, a plate shape or a film shape. The sensor 30A has a first surface and a second surface opposite to the first surface. The shape of the sensor 30A in plan view, that is, the shapes of the first surface and the second surface in plan view may be a quadrangular shape such as a square shape. However, the shape of the sensor 30A in plan view is not limited to the quadrangular shape, and may be a circular shape, an elliptical shape, or the like.

The sensor 30A includes a plurality of sensor units 30SE. The plurality of sensor units 30SE are two-dimensionally arranged in an in-plane direction (X and Y directions) of the first surface or the second surface of the sensor 30A. Each sensor unit 30SE has a central axis 30L parallel to the thickness direction of the sensor 30A. The central axis 30L passes through the center position of the reflection unit 25 and the center of the light receiving unit group 23 in a state where no force is applied to the first surface or the second surface of the sensor 30. In Modification 1, a direction parallel to the central axis 30L, that is, a direction perpendicular to the first surface of the sensor 30A is referred to as a Z direction (third direction). Two directions orthogonal to the Z direction and orthogonal to each other, that is, two directions orthogonal to each other in a plane parallel to the first surface of the sensor 30A are referred to as an X direction (first direction) and a Y direction (second direction).

The sensor 30A includes a base material layer 31, a plurality of light receiving unit groups 23, an elastic layer 32, a plurality of reflection units 25, and a light shielding layer 33. Note that, in Modification 1, the same reference numerals are given to the parts similar to those of one embodiment. The base material layer 31, the elastic layer 32, and the light shielding layer 33 are laminated in this order, the light shielding layer 33 is on the first surface side of the sensor 30A, and the base material layer 31 is on the second surface side of the sensor 30A.

### (Base Material Layer 31)

The base material layer 31 includes a base material 31A, a plurality of light sources 22, a bonding layer 31B, a light transmission layer 31C, and a light shielding layer 31D. The base material layer 31 may include a reflection layer instead of the light shielding layer 31D.

### (Base Material 31A)

The base material 31A can support the plurality of light sources 22 and the light transmission layer 31C. The base material 31A may be similar to the base material 21 in one embodiment in points other than the above. The base material 31A may be constituted by a reflection layer, or may be constituted by a laminate of a substrate or a film and a reflection layer.

### (Light Source 22)

The plurality of light sources 22 are two-dimensionally arranged on the base material 31A in a prescribed arrangement pattern such as a matrix shape. The light source 22 is provided for each sensor unit 30SE. Each light source 22 is located immediately below a pinhole 31DA.

### (Bonding Layer 31B)

The bonding layer 31B bonds the base material 31A and the light transmission layer 31C together. The bonding layer 31B may cover the light source 22 or may have a hole in the portion of the light source 22. FIG. 20 shows an example in which the bonding layer 31B has a hole in the portion of the light source 22. In a case where the bonding layer 31B covers the light source 22, the bonding layer 31B preferably has translucency with respect to light emitted from the light source 22. In a case where the bonding layer 31B has a hole in the portion of the light source 22, the bonding layer 31B may have translucency with respect to light emitted from the light source 22 or may have non-translucency with respect to light emitted from the light source 22. The bonding layer 31B is provided between the base material 31A and the light transmission layer 31C. The bonding layer is, for example, a pressure-sensitive adhesive layer or an adhesive layer.

### (Light Transmission Layer 31C)

The light transmission layer 31C has translucency with respect to light emitted from the light source 22. For example, in a case where the light source 22 is configured to be able to emit visible light such as white light, red light, green light, or blue light, the light transmission layer 31C may have transparency with respect to visible light. The light transmission layer 31C is provided on the bonding layer 31B. The light transmission layer 31C is bonded to the base material 31A by the bonding layer 31B.

The light transmission layer 31C is a substrate or a film. The substrate is, for example, a glass substrate or a resin substrate. The film is, for example, a glass film or a resin film. The resin substrate and the resin film contain a resin material. The resin material includes, for example, at least one plastic material selected from the group consisting of polymethyl methacrylate, polystyrene, polycarbonate, polyether sulfone, polyarylate, amorphous polyolefin, cycloolefin polymer, cycloolefin copolymer, triacetyl cellulose, epoxy resin, and the like.

### (Light Shielding Layer 31D)

The light shielding layer 31D has a plurality of pinholes 31DA. The pinhole 31DA is an example of the hole. The light emitted from the light source 22 is extracted from the light transmission layer 31C to the elastic layer 32 by the pinhole 31DA. The light extracted to the elastic layer 32 illuminates the reflection unit 25.

The pinhole 31DA penetrates in the thickness direction of the light shielding layer 31D. The pinhole 31DA is provided for each sensor unit 30SE. The pinhole 31DA is located immediately below the reflection unit 25 and is located immediately above the light source 22 in a state where no force is applied to the sensor 30. In a state where no force is applied to the sensor 30, the center position of the light source 22, the center position of the pinhole 31DA, and the center position of the reflection unit 25 are located on the central axis 30L.

### (Light Receiving Unit Group 23)

The light receiving unit group 23 is provided for each sensor unit 30SE. Each light receiving unit group 23 is disposed on the base material layer 31, specifically, the light shielding layer 31D such that each pinhole 31DA is located at the center of the light receiving unit group 23. The first light receiving units 23A₁ to 23A₆ are arranged in the X direction to form a row. The first light receiving units 23A₁ to 23A₆ constituting the row are arranged symmetrically with respect to the center of the light receiving unit group 23, that is, with respect to the central axis 30L. The second light receiving units 23B₁ to 23B₆ are arranged in the Y direction to form a row. The second light receiving units 23B₁ to 23B₆ constituting the row are arranged symmetrically with respect to the center of the light receiving unit group 23, that is, with respect to the central axis 30L.

### (Elastic Layer 32)

The elastic layer 32 can be elastically deformed in the +X direction, the +X direction, and the −Z direction. The elastic layer 32 has translucency with respect to light emitted from the light source 22. For example, in a case where the light source 22 is configured to be able to emit visible light such as white light, red light, green light, or blue light, the elastic layer 32 may have transparency with respect to the visible light. The elastic layer 32 may be colored. The elastic layer 32 is provided between the plurality of reflection units 25 and the plurality of light receiving unit groups 23. More specifically, the elastic layer 32 is provided on the base material layer 31 so as to cover the plurality of light receiving unit groups 23. The material of the elastic layer 32 may be similar to the material of the elastic body 24 in one embodiment.

### (Reflection Unit 25)

The plurality of reflection units 25 are two-dimensionally arranged on the elastic layer 32 in a prescribed arrangement pattern such as a matrix shape. Each reflection unit 25 is provided above the light receiving unit group 23. More specifically, each reflection unit 25 is located immediately above pinhole 31DA.

### (Light Shielding Layer 33)

The light shielding layer 33 is provided on the elastic layer 32 so as to cover the plurality of reflection units 25 arranged two-dimensionally. The light shielding layer 33 may be similar to the light shielding layer 26 in one embodiment in points other than the above.

### [Operations and Effects]

In the sensor 30A of Modification 1, the light emitted upward from the light source 22 is extracted into the elastic layer 32 through the pinhole 31DA of the light shielding layer 31D. The light extracted into the elastic layer 32 is reflected by the reflection unit 25, and is then incident on the first light receiving units 23A₁ to 23A₆ and the second light receiving units 23B₁ to 23B₆. When a force acts on the first surface (upper surface) of the sensor 30A, the elastic layer 32 is deformed, and the center position of the reflection unit 25 is displaced in at least one of the +X direction, the +Y direction, and the −Z direction. The orientation distribution of the reflected light of the reflection unit 25 changes with the displacement of the center position of the reflection unit 25. The amount of light received by each of the first light receiving units 23A₁ to 23A₆ and the second light receiving units 23B₁ to 23B₆ changes according to the change in the orientation distribution, and the output signals SA₁ to SA₆ and SB₁ to SB₆ from the first light receiving units 23A1 to 23A₆ and the second light receiving units 23B₁ to 23B₆ change. The IC can detect the forces F_{X}, F_{Y}, and F_{Z} acting on the sensor 30A on the basis of the changes in the output signals SA₁ to SA₆ and SB₁ to SB₆.

The sensor 30A of Modification 1 includes the light source 22 and the first and second light receiving units 23A and 23B in separate layers. Therefore, the sensor 30A can be manufactured without precisely aligning and mounting different types of components of the light source 22 and the first and second light receiving units 23A and 23B in the same plane. In addition, since the light source 22 and the first and second light receiving units 23A and 23B are provided in separate layers, the limitation on the size of the light source 22 is also relaxed. Therefore, the sensor 30A can be easily manufactured as compared with the sensor 20 of one embodiment.

### <Modification 2>

### [Configuration of Sensor 30B]

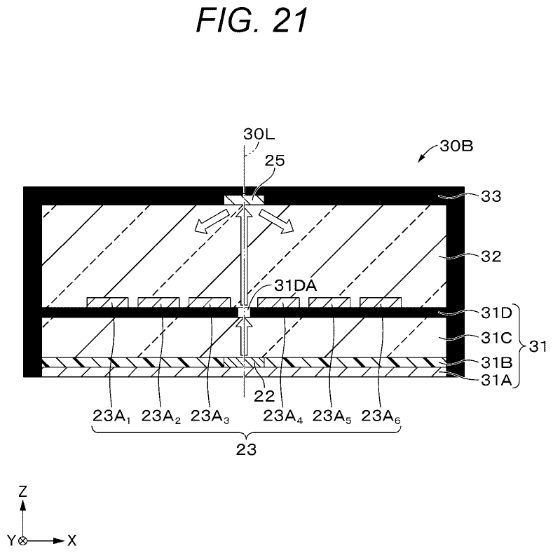

FIG. 21 is a cross-sectional view illustrating an example of a configuration of a sensor 30B of Modification 2. The sensor 30B is different from the sensor 30A of the first modification in including one sensor unit 30SE instead of the plurality of two-dimensionally arranged sensor units 30SE (see FIG. 20). The light shielding layer 33 covers the upper surface of the elastic layer 32 (surface opposite to the base material layer 31) and covers the side surface of the elastic layer 32. The light shielding layer 33 may further cover the side surface of the base material layer 31. Since the side surface of the elastic layer 32 is covered with the light shielding layer 33, incidence of external light from the side surface into the elastic layer 32 is suppressed.

The sensor 30B is manufactured, for example, as follows. After a laminate including the base material layer 31, the light receiving unit group 23, and the elastic layer 32 is formed, the laminate is cut out for each region including one sensor unit 30SE. The light shielding layer 33 is formed so as to cover both the first surface and the side surface of the cut elastic layer 32.

### <Modification 3>

### [Configuration of Sensor 30C]

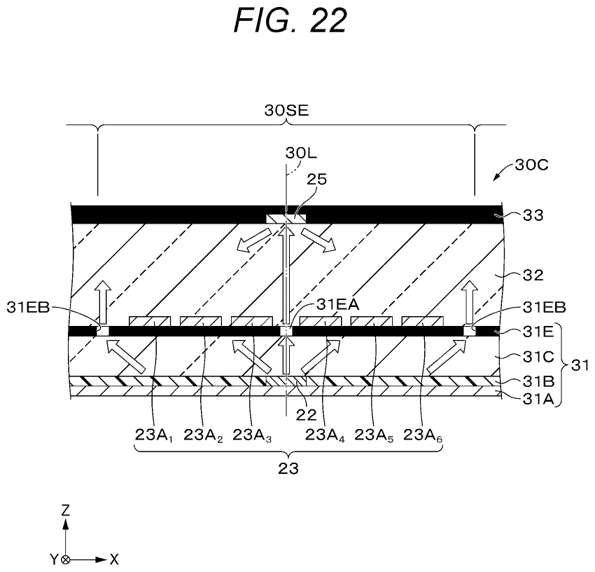

FIG. 22 is a cross-sectional view illustrating an example of a configuration of a sensor 30C of Modification 3. The sensor 30C is different from the sensor 30A (see FIG. 20) of Modification 1 in including a diffuse reflection layer as the reflection unit 25 and including a light shielding layer 31E instead of the light shielding layer 31D.

### (Reflection Unit 25)

The diffuse reflection layer as the reflection unit 25 is as described in one embodiment.

### (Light Shielding Layer 31E)

The light shielding layer 31E has a plurality of pinholes 31EA and a plurality of holes 31EB. The pinhole 31EA is similar to the pinhole 31DA in Modification 1.

The pinhole 31EA and the plurality of holes 31EB can extract the light emitted from each light source 22 from the light transmission layer 31C to the elastic layer 32. The hole 31EB penetrates in the thickness direction of the light shielding layer 31E. The hole 31EB has, for example, a dot shape or a slit shape in plan view. The holes 31EB are provided in a region other than the formation region of the pinhole 31EA and the plurality of first and second light receiving units 23A and 23B in the light shielding layer 31E. The hole 31EB may be provided in a region outside the region in which the light receiving unit group 23 is provided, or may be provided in a region in which the light receiving unit group 23 is provided. The plurality of holes 31EB are preferably provided on the circumference centered on the pinhole 31EA. In this case, the distance between the adjacent holes 31EB is preferably equal.

### [Operations and Effects]

The sensor 30C of Modification 3 includes the light shielding layer 31E having the plurality of pinholes 31EA and the plurality of holes 31EB. The light emitted from each light source 22 is extracted from the light transmission layer 31C to the elastic layer 32 by the pinhole 31EA and the plurality of holes 31EB. The light extracted from the light transmission layer 31C to the elastic layer 32 illuminates the reflection unit 25. The irradiation light is diffusely reflected by the reflection unit 25, and the diffusely reflected light is incident on the first light receiving units 23A₁ to 23A₆ and the second light receiving units 23B₁ to 23B₆. As a result, the amount of light illuminating the reflection unit 25 increases as compared with the sensor 30A of Modification 1 including the light shielding layer 31D having only the pinhole 31DA. In addition, by irradiating the reflection unit 25 with the light extracted from the plurality of holes 31EB from multiple directions, the intensity of the diffused light is increased, and the uniformity of the alignment light distribution is enhanced.

In Modification 3 described above, an example in which the light shielding layer 31E has the plurality of holes 31EB having a dot shape or a slit shape in plan view has been described, but the light shielding layer 31E may have one or a plurality of holes 31EB having a closed loop shape in plan view. The closed loop shaped hole 31EB is preferably centered on the pinhole 31EA. The closed loop shape is, for example, an annular shape of a polygon such as an annular shape, an elliptical ring shape, or a regular polygon shape. The plurality of closed loop shaped holes 31EB are preferably provided concentrically around the pinhole 31EA.

### <Modification 4>

### [Configuration of Sensor 30D]

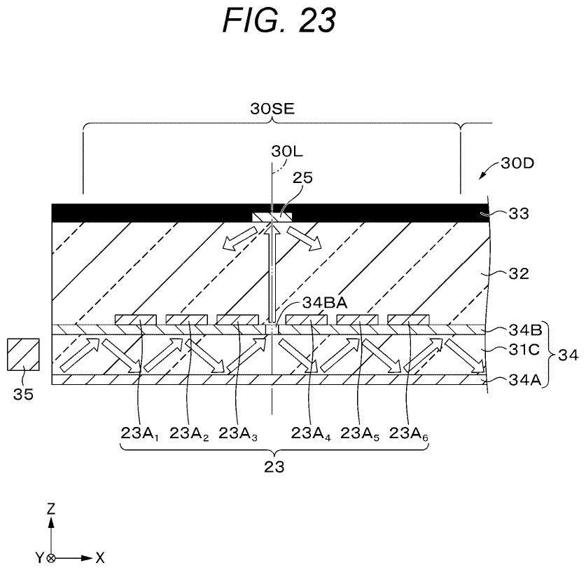

FIG. 23 is a cross-sectional view illustrating an example of a configuration of a sensor 30D of Modification 4. The sensor 30D of Modification 4 is different from the sensor 30A (see FIG. 20) of Modification 1 in that a light guiding layer 34 is provided instead of the base material layer 31 including the plurality of light sources 22.

### (Light Source 35)

The light source 35 is disposed to face the side surface of the light guiding layer 34. The light source 35 can cause light to be incident on the light guiding layer 34 from a side surface of the light guiding layer 34. The type of the light source 35 may be, for example, similar to the light source 22 in one embodiment.

### (Light Guiding Layer)

The light guiding layer 34 has a plurality of pinholes 34BA on a first surface on which the light receiving unit group 23 is provided. The position of the pinhole 34BA is similar to the position of the pinhole 31DA in Modification 1. The light guiding layer 34 can guide light incident from the side surface in an in-plane direction (X and Y directions) of a first surface of the sensor 30D and emit the light from the plurality of pinholes 34BA to the elastic layer 32.

The light guiding layer 34 includes a reflection layer 34A, a light transmission layer 31C, and a reflection layer 34B. The light transmission layer 31C has translucency with respect to light incident from the light source 35. The light transmission layer 31C is provided between the reflection layers 34A and 34B.

The reflection layers 34A and 34B can reflect light incident from the side surface of the light guiding layer 34. The reflection layers 34A and 34B are separated such that principal surfaces thereof are parallel to each other. The reflection layer 34A is provided on a second surface of the light transmission layer 31C. The reflection layer 34B is provided on a first surface of the light transmission layer 31C. The reflection layer 34B has the plurality of pinholes 34BA. The pinholes 34BA penetrate the reflection layer 34B. The pinholes 34BA can extract light from the light transmission layer 31C to the elastic layer 32.

The reflection layers 34A and 34B are, for example, metal layers. The metal layer contains, for example, at least one selected from the group consisting of chromium (Cr), gold (Au), platinum (Pt), nickel (Ni), copper (Cu), molybdenum (Mo), titanium (Ti), tantalum (Ta), aluminum (Al), magnesium (Mg), iron (Fe), tungsten (W), and silver (Ag).

### [Operations and Effects]

In the sensor 30D of Modification 4, the light incident from the side surface of the light guiding layer 34 is guided by the light guiding layer 34 in the in-plane direction of the first surface of the sensor 30D, and is emitted from the plurality of pinholes 34BA provided in the first surface of the light guiding layer 34. Therefore, like the sensor 30A of Modification 1, the light source 22 may not be provided for each sensor unit 30SE. Therefore, in the sensor 30D of Modification 4, the number of components can be reduced as compared with the sensor 30A of Modification 1. Therefore, in the sensor 30D of Modification 4, the sensor structure can be simplified as compared with the sensor 30A of Modification 1.

### <Modification 5>

### [Configuration of Sensor 30E]

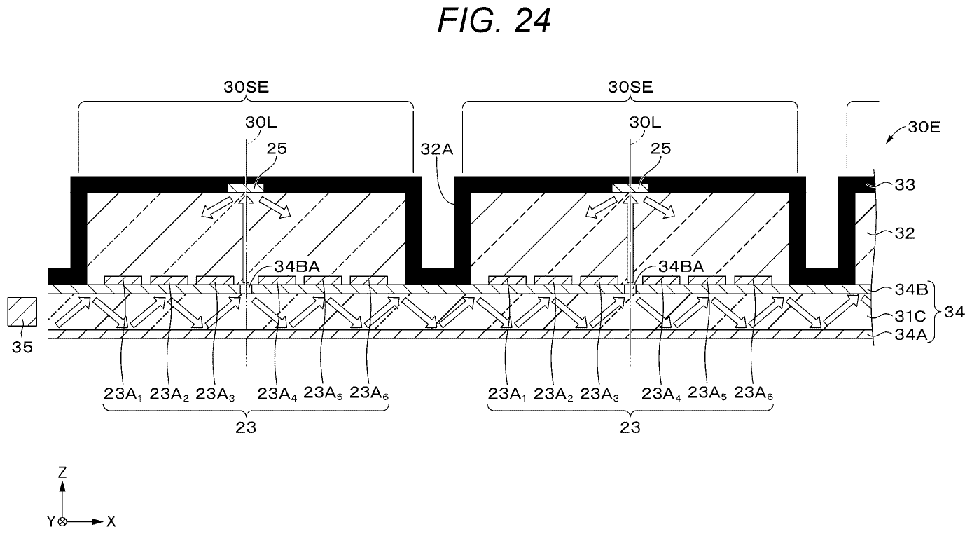

FIG. 24 is a cross-sectional view illustrating an example of a configuration of a sensor 30E of Modification 5. The sensor 30E is different from the sensor 30A (see FIG. 20) of Modification 1 in that a groove 32A is provided in the elastic layer 32.

The groove 32A is provided between the adjacent sensor units 30SE in plan view. The groove 32A has, for example, a lattice shape in plan view. The elastic layer 32 may be divided by the groove 32A, or may be connected at the bottom portion of the groove 32A without being divided by the groove 32A. The elastic layer 32 has an upper surface and a side surface formed by the groove 32A. Here, the upper surface of the elastic layer 32 represents a surface on a side opposite to the light guiding layer 34 on which the reflection unit 25 is supported. The elastic layer 32 having the groove 32A may be formed by injection molding using a mold, may be formed by laser processing, or may be formed by photolithography and etching.

The light shielding layer 33 preferably covers both the upper surface and the side surface of the elastic layer 32. As a result, incidence of external light into the elastic layer 32 from the upper surface and the side surface of the elastic layer 32 is suppressed. The light shielding layer 33 may be formed so as to follow the groove 32A after the groove 32A is formed in the elastic layer 32, or may be molded by a mold. The light shielding layer 33 may fill the groove 32A or may follow the groove 32A.

### [Operations and Effects]

In the sensor 30E of Modification 5, since the groove 32A is provided in the elastic layer 32, even in a case where the elastic layer 32 of one sensor unit 30SE is greatly deformed, the elastic layer 32 of the adjacent sensor unit 30SE is hardly affected by the deformation. That is, the forces applied to the sensor units 30SE can be made independent.

### <Modification 6>

### [Configuration of Sensor 30F]

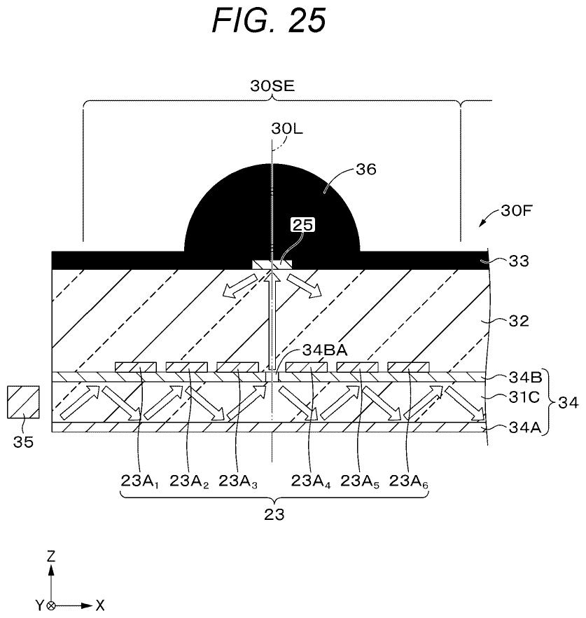

FIG. 25 is a cross-sectional view illustrating an example of a configuration of a sensor 30F of Modification 6. The sensor 30F is different from the sensor 30D (see FIG. 23) of Modification 4 in that a protrusion 36 is provided on a first surface.

### (Protrusion 36)

The protrusion 36 is provided at a position corresponding to the reflection unit 25. Specifically, the protrusion 36 is provided above the reflection unit 25. The protrusion 36 may be made of the same material as the light shielding layer 33, or may be made of a material different from the light shielding layer 33. In order to easily transmit the force acting on the protrusion 36 to the elastic layer 32, the hardness of the protrusion 36 is preferably harder than the hardness of the elastic layer 32. Here, the hardness represents the indentation hardness (Vickers hardness). In order to easily transmit the force acting on the protrusion 36 to the elastic layer 32, the Young's modulus of the protrusion 36 is preferably larger than the Young's modulus of the elastic layer 32.

### [Operations and Effects]

In the sensor 30F of Modification 6, the protrusion 36 is provided on a first surface of the sensor 30F. As a result, when a force acts on the protrusion 36, a portion of the elastic layer 32 located below the protrusion 36 is easily deformed. Therefore, the sensitivity of the sensor 30F is improved as compared with the sensitivity of the sensor 30D of Modification 4.

### <Modification 7>

### [Configuration of Sensor 30G]

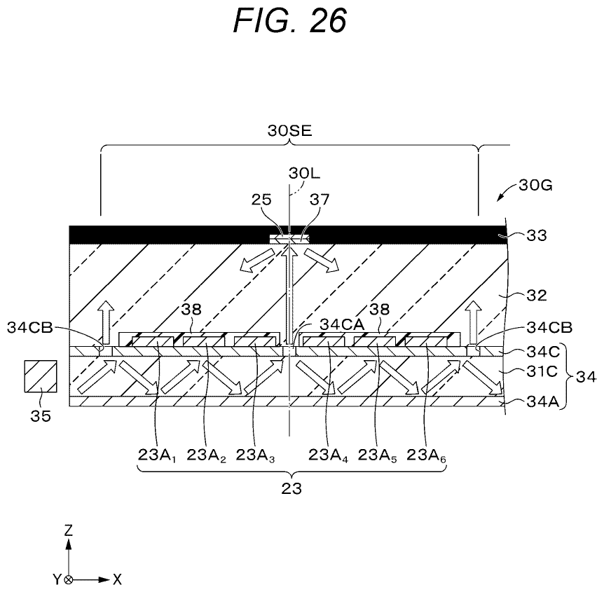

FIG. 26 is a cross-sectional view illustrating an example of a configuration of a sensor 30G of Modification 7. The sensor 30G is different from the sensor 30D (see FIG. 23) of Modification 4 in that the sensor 30G includes a reflection layer 34C in place of the reflection layer 34B, and further includes a wavelength conversion layer 37 and a color filter 38. In Modification 7, an example in which the sensor 30G includes the reflection layer 34C instead of the reflection layer 34B will be described, but the sensor 30G may include the reflection layer 34B.

### (Reflection Layer 34C)

The reflection layer 34C has a pinhole 34CA and a plurality of holes 34CB. The pinhole 34CA is similar to the pinhole 34BA in Modification 4. The pinhole 34CA and the plurality of holes 34CB can extract the light emitted from the light source 22 from the light transmission layer 31C to the elastic layer 32. The light extracted to the elastic layer 32 illuminates the wavelength conversion layer 37 and the reflection unit 25. The hole 34CB penetrates in the thickness direction of the reflection layer 34B. The hole 34CB has, for example, a dot shape or a slit shape in plan view. The hole 34CB is provided in a region of the reflection layer 34B other than a formation region of the pinhole 34CA and the plurality of first and second light receiving units 23A and 23B. The hole 34CB may be provided in a region outside the region in which the light receiving unit group 23 is provided, or may be provided in a region in which the light receiving unit group 23 is provided. The plurality of holes 34CB are preferably provided on the circumference centered on the pinhole 34CA. In this case, the distance between the adjacent holes 34CB is preferably equal.

The reflection layer 34C may have one or a plurality of holes 34CB having a closed loop shape in plan view instead of the hole 34CB having a dot shape or a slit shape or together with the hole 34CB having a dot shape or a slit shape. The closed loop shaped hole 34CB is preferably centered on the pinhole 34CA. The closed loop shape is, for example, an annular shape of a polygon such as an annular shape, an elliptical ring shape, or a regular polygon shape. The plurality of holes 34CB having a closed loop shape are preferably provided concentrically around the pinhole 34CA.

### (Wavelength Conversion Layer 37)

The wavelength conversion layer 37 can absorb energy of first light and emit second light having different energy. Specifically, the wavelength conversion layer 37 can absorb the first light having a first peak wavelength and convert the first light into the second light having a second peak wavelength. The first light is included in the light emitted from the light source 35, that is, the light emitted from the plurality of pinholes 34CA and the plurality of holes 34CB. For example, in a case where the light source 35 is a blue light source capable of emitting blue light, the wavelength conversion layer 37 may be a color conversion layer capable of absorbing blue light and performing color conversion into red light.

The plurality of wavelength conversion layers 37 are two-dimensionally arranged on the elastic layer 32 in a prescribed arrangement pattern such as a matrix shape. The wavelength conversion layer 37 is provided between the reflection unit 25 and the elastic layer 32. The reflection unit 25 may be laminated on the wavelength conversion layer 37. The wavelength conversion layer 37 includes a phosphor or a quantum dot. The wavelength conversion layer 37 may contain a binder as necessary.

### (Color Filter 38)

The color filter 38 can transmit the second light emitted from the wavelength conversion layer 37, and can absorb the first light and the like other than the second light. In a case where the light source 35 is a blue light source capable of emitting blue light and the wavelength conversion layer 37 is a color conversion layer capable of absorbing blue light and performing color conversion into red light, the color filter 38 may be a red filter capable of absorbing blue light while transmitting red light.

The color filter 38 is provided on the reflection layer 34C so as to cover the light receiving unit group 23. The color filter 38 includes, for example, a color resist such as a red color resist. The pinhole 34CA and the plurality of holes 34CB are preferably exposed without being covered with the color filter 38.

In Modification 7 described above, an example in which the sensor 30G includes the wavelength conversion layer 37 and the reflection unit 25 has been described, but the sensor 30G may include a diffuse reflection layer instead of the wavelength conversion layer 37 and the reflection unit 25. In this case, the light that can be emitted from the light source 35 may be white light or the like. In Modification 7 described above, an example in which the sensor 30G includes the reflection unit 25 has been described, but the sensor 30G may not include the reflection unit 25.

### [Operations and Effects]

In the sensor 30G of Modification 7, the wavelength conversion layer 37 can absorb the energy of the first light emitted from the pinhole 34CA and the plurality of holes 34CB and emit the second light having different energy. The color filter 38 transmits the second light emitted from the wavelength conversion layer 37, but can absorb the first light and the like other than the second light. As a result, it is possible to suppress incidence of the first light and the like other than the second light on the light receiving unit group 23. Therefore, noise (noise caused by the first light and the like) of the output signal of the light receiving unit group 23 can be reduced.

### <Modification 8>

### [Configuration of Sensor 30H]

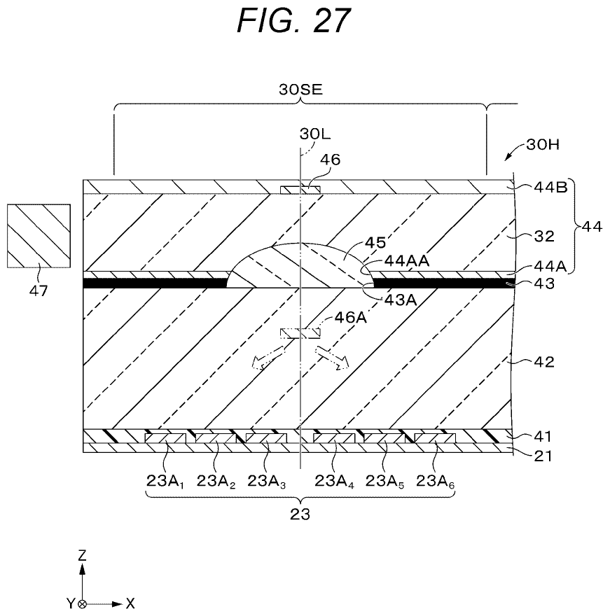

FIG. 27 is a cross-sectional view illustrating an example of a configuration of a sensor 30H of Modification 8. The sensor 30H includes a base material 21, a plurality of light receiving unit groups 23, a color filter 41, a light transmission layer 42, a light shielding layer 43, a light guiding layer 44, and a plurality of lenses 45. Note that, in Modification 8, the same reference numerals are given to the parts similar to those of one embodiment.

### (Light Source 47)

The light source 47 is disposed to face the side surface of the light guiding layer 44. The light source 47 can cause light to be incident on the light guiding layer 44 from a side surface of the light guiding layer 44. The type of the light source 47 may be, for example, similar to the light source 22 in one embodiment.

### (Light Guiding Layer 44)

The light guiding layer 44 can guide light incident from the side surface in an in-plane direction (X and Y directions) of a first surface of the sensor 30H and can cause the light to be incident on a plurality of wavelength conversion layers 46. The light guiding layer 44 includes a reflection layer 44A, an elastic layer 32, the plurality of wavelength conversion layers 46, and a reflection layer 44B.

The elastic layer 32 has translucency with respect to light incident from the light source 47. The elastic layer 32 is provided between the reflection layers 44A and 44B.

The plurality of wavelength conversion layers 46 are two-dimensionally arranged on the elastic layer 32 in a prescribed arrangement pattern such as a matrix shape. The plurality of wavelength conversion layers 46 are similar to the wavelength conversion layer 37 in Modification 7.

The reflection layers 44A and 44B can reflect light incident from the side surface of the elastic layer 32. The reflection layers 44A and 44B are separated such that principal surfaces thereof are parallel to each other. The reflection layer 44A is provided on the second surface of the elastic layer 32. The reflection layer 44B is provided on a first surface of the elastic layer 32 so as to cover the plurality of wavelength conversion layers 46. The reflection layer 44A has a plurality of holes 44AA. Each hole 44AA is provided at an arrangement position of the lens 45.

The reflection layers 44A and 44B are, for example, metal layers. The metal layer contains, for example, at least one selected from the group consisting of chromium (Cr), gold (Au), platinum (Pt), nickel (Ni), copper (Cu), molybdenum (Mo), titanium (Ti), tantalum (Ta), aluminum (Al), magnesium (Mg), iron (Fe), tungsten (W), and silver (Ag).

### (Base Material 21)

The base material 21 is as described in one embodiment.

### (Light Receiving Unit Group 23)

The light receiving unit group 23 is as described in one embodiment.

### (Color Filter 41)

The color filter 41 transmits the second light emitted from the wavelength conversion layer 46, but can absorb the first light and the like other than the second light. In a case where the light source 47 is a blue light source capable of emitting blue light and the wavelength conversion layer 46 is a color conversion layer capable of absorbing blue light and performing color conversion into red light, the color filter 41 may be a red filter capable of absorbing blue light while transmitting red light.

The color filter 41 is provided on the base material 21 so as to cover the light receiving unit group 23. The color filter 41 includes, for example, a color resist such as a red color resist.

### (Light Transmission Layer 42)

The light transmission layer 42 has translucency with respect to light emitted from the light source 47. For example, in a case where the light source 22 is configured to be able to emit visible light such as white light, red light, green light, or blue light, the light transmission layer 42 may have transparency with respect to the visible light. The light transmission layer 42 is provided between the elastic layer 32 and the plurality of light receiving unit groups 23. More specifically, the light transmission layer 42 is provided on the color filter 41.

The light transmission layer 42 is a substrate or a film. The substrate may be similar to the substrate constituting the light transmission layer 31C in Modification 1. The film may be similar to the film constituting the light transmission layer 31C in Modification 1.

### (Light Shielding Layer 43)

The light shielding layer 43 can absorb incident light. The incident light is, for example, outgoing light of the light source 47, emission light of the wavelength conversion layer 46, and the like. The light shielding layer 26 is provided on the light transmission layer 42. The light shielding layer 26 has a plurality of holes 43A. Each hole 43A is provided at an arrangement position of the lens 45. The light shielding layer 26 may include, for example, a material similar to the light shielding layer 26 in one embodiment.

### (Lens 45)

The lens 45 can form one image 46A of the wavelength conversion layer 46 provided immediately above the lens 45 on the light transmission layer 42. The plurality of lenses 45 are two-dimensionally arranged on the light transmission layer 42 in a prescribed arrangement pattern such as a matrix shape. Each lens 45 is provided in the hole 43A of the light shielding layer 43 and the hole 44AA of the reflection layer 44A, and protrudes into the light guiding layer 44. The geometric center of each lens 45 in plan view is located on the central axis 30L.

In Modification 8 described above, an example in which the sensor 30H includes the wavelength conversion layer 46 has been described, but a diffuse reflection layer may be provided instead of the wavelength conversion layer 46. In this case, the light that can be emitted from the light source 47 may be white light or the like. In Modification 8 described above, an example in which the light guiding layer 44 includes the reflection layer 44B has been described, but the light guiding layer 44 may include a diffuse reflection layer instead of the reflection layer 44B. In this case, the wavelength conversion layer 46 may or may not be provided.

### [Operations and Effects]

In the sensor 30H of Modification 8, a virtual image 46A of the wavelength conversion layer 46 is formed in the light transmission layer 42 by the lens 45. The light distribution of the emission light of the image 46A is received by the first light receiving units 23A₁ to 23A₆ and the second light receiving units 23B₁ to 23B₆. Therefore, even in a case where the position of the wavelength conversion layer 46 is far from the light receiving unit group 23, the positions X, Y, and Z of the wavelength conversion layer 46 can be detected.

The color filter 41 transmits the second light emitted from the wavelength conversion layer 46, but can absorb the first light and the like other than the second light. As a result, it is possible to suppress incidence of the first light and the like other than the second light on the light receiving unit group 23. Therefore, noise (noise caused by the first light and the like) of the output signal of the light receiving unit group 23 can be reduced.

### <Modification 9>

In Modification 8, an example in which one virtual image 46A is formed by one lens 45 has been described. On the other hand, in Modification 9, an example in which a plurality of virtual images 46A are formed by one lens 45 will be described.

### [Configuration of Sensor 30I]

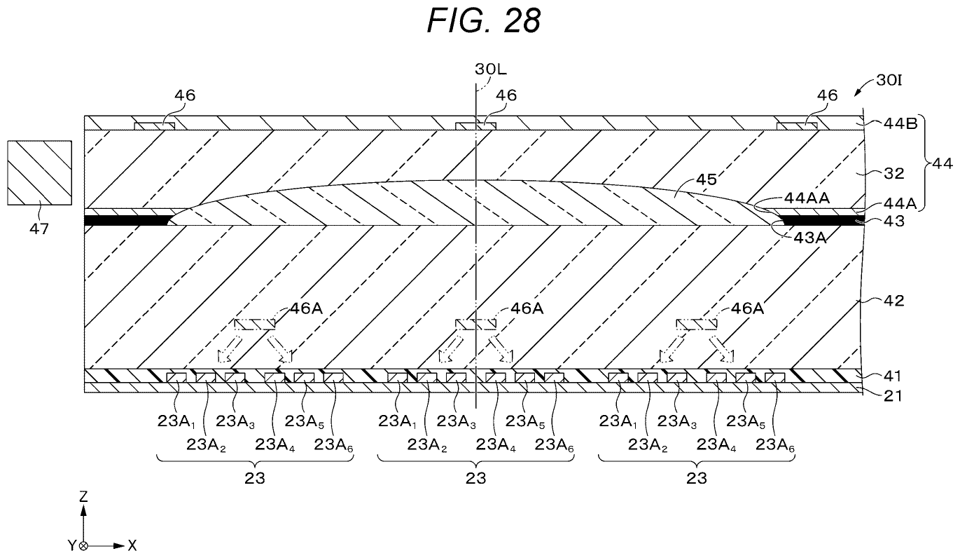

FIG. 28 is a cross-sectional view illustrating an example of a configuration of a sensor 30I of Modification 9. A plurality of wavelength conversion layers 46 are provided corresponding to one lens 45. A plurality of light receiving unit groups 23 are provided corresponding to one lens 45. One lens 45 can form a plurality of images 46A corresponding to the plurality of wavelength conversion layers 46 provided corresponding to the lens 45 on the light transmission layer 42. Each image 46A is formed above the light receiving unit group 23.

The components such as the plurality of light receiving unit groups 23 and the lens 45 may be general-purpose components used in a digital camera or the like. By using such a general-purpose component, the sensor 30I can be manufactured at low cost.

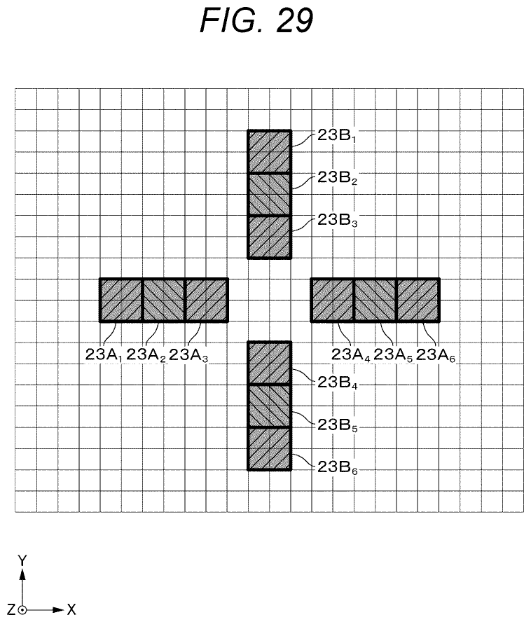

As illustrated in FIG. 29, the plurality of first light receiving units 23A₁ to 23A₆ and the plurality of second light receiving units 23B₁ to 23B₆ may be configured by a photodiode array or an image sensor. For example, each of the first light receiving units 23A and each of the second light receiving units 23B may include one light receiving element (for example, a pixel) included in the photodiode array or the image sensor, or may include one section of light receiving elements included in the photodiode array or the image sensor.

In a case where each of the first light receiving units 23A and each of the second light receiving units 23B include one section of the light receiving elements included in the photodiode array or the image sensor, the IC 11 may set the sum of the output signals of the light receiving elements of the one section as the output signal from one first light receiving unit 23A or one second light receiving unit 23B.

The image sensor may be a general-purpose component used in a digital camera or the like. By using such a general-purpose component, the sensor 30I can be manufactured at low cost. In addition, the plurality of light receiving unit groups 23 can be configured without mounting the plurality of light receiving elements one by one. Therefore, the productivity of the sensor 30I can be improved.

### <Modification 10>

### [Configuration of Sensor 30J]

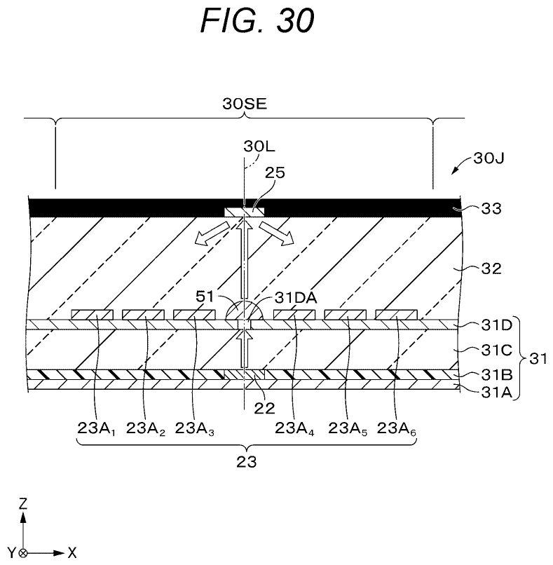

FIG. 30 is a cross-sectional view illustrating an example of a configuration of a sensor 30J of Modification 10. The sensor 30J is different from the sensor 30A of Modification 1 in including a lens 51. The lens 51 can collect the light emitted from the pinhole 31DA and adjust the light distribution of the incident light on the reflection unit 25. Therefore, the light distribution of the reflected light by the reflection unit 25 can be adjusted.

The lens 51 is provided on the pinhole 31DA or above the pinhole 31DA. The optical axis of the lens 51 coincides with the central axis 30L. The lens 51 may be an aspherical lens. The aspherical lens may adjust the light distribution of the reflected light of the reflection unit 25 to enlarge the linear region of the light distribution. In this case, the detection error of the sensor 30J can be reduced, and the dynamic range can be enlarged.

### [Operations and Effects]

In the sensor 30J of Modification 10, the lens 51 is provided on the pinhole 31DA or above the pinhole 31DA. As a result, the irradiation range of the pinhole 31DA is concentrated on the movable range of the reflection unit 25, and it is possible to reduce wasted light without contributing to sensing in the periphery of the reflection unit 25. Therefore, the light utilization efficiency of the sensor 30J can be increased, and better sensitivity can be obtained even with the same power consumption.

### <Modification 11>

### [Configuration of Sensor 20K]

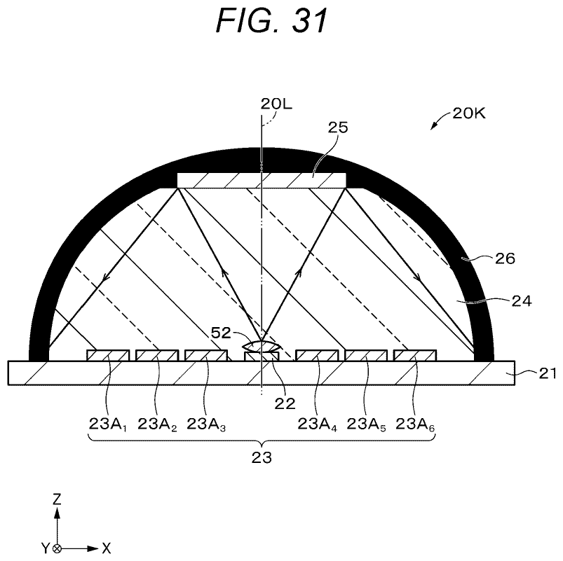

FIG. 31 is a cross-sectional view illustrating an example of a configuration of a sensor 20K of Modification 11. The sensor 20K is different from the sensor 20 according to one embodiment in including a lens 52. The lens 52 is provided on the light source 22 or above the light source 22. The optical axis of the lens 52 coincides with the central axis 20L. The lens 52 may be an aspherical lens. The aspheric lens may have a function similar to that of the aspheric lens in Modification 10.

### [Operations and Effects]

In the sensor 20K of Modification 11, the sensor is provided on the light source 22 or above the light source 22. As a result, the irradiation range of the light source 22 is concentrated on the movable range of the reflection unit 25, and it is possible to reduce wasted light without contributing to sensing in the periphery of the reflection unit 25. Therefore, the light utilization efficiency of the sensor 20K can be increased, and better sensitivity can be obtained even with the same power consumption.

### [Modification of Light Receiving Unit Group 23]

In one embodiment and the modifications 1 to 11, an example has been described in which the sensor 20 and the sensors 30A to 30J and 20K include the light receiving unit group 23 in which the plurality of first and second light receiving units 23A and 23B are arranged in a cross shape. However, the sensor 20 and the sensors 30A to 30J and 20K may include any one of the light receiving unit groups 61 and 62 of following Modifications 12 and 13.

### <Modification 12>

### [Configuration of Light Receiving Unit Group 61]

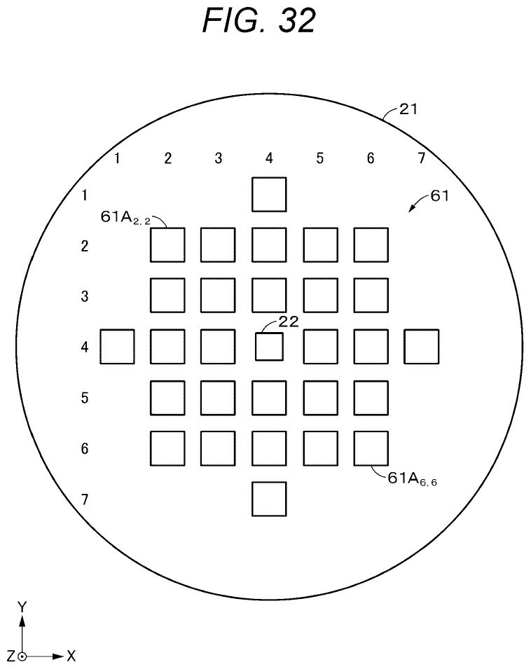

FIG. 32 is a plan view illustrating an example of a configuration of a light receiving unit group 61 of Modification 12. The light receiving unit group 61 includes a plurality of light receiving units 61A_{m,n} (here, m and n are positive integers). The plurality of light receiving units 61A_{m,n}, are two-dimensionally arranged in a matrix on the base material 21. In FIG. 32, numerical values 1, 2, . . . , and 7 arranged in the Y direction represent a row number m of the light receiving unit 61A_{m,n}, and numerical values 1, 2, . . . , and 7 arranged in the X direction represent a column number n of the light receiving unit 61A_{m,n}. The light receiving unit 61A_{m,n} represents a light receiving unit arranged at a position of m rows and n columns. For example, the light receiving unit 61A_{2,2} represents a light receiving unit arranged at a position of 2 rows and 2 columns, and the light receiving unit 61A_{6,6} represents a light receiving unit arranged at positions of 6 rows and 6 columns. The light source 22 is arranged at the center position of the light receiving unit group 61.

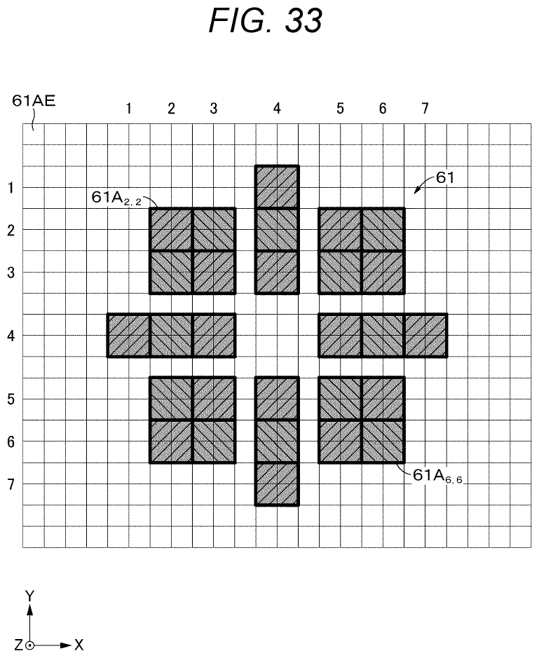

As illustrated in FIG. 33, the plurality of light receiving units 61A_{m,n} may include a photodiode array or an image sensor. For example, each of the light receiving units 61A_{m,n} may include one light receiving element (for example, pixel) 61AE included in the photodiode array or the image sensor, or may include one section of the light receiving elements 61AE included in the photodiode array or the image sensor. In this case, one or more light sources 22 may be arranged in the periphery of the light receiving unit group 23, and light may be emitted from the periphery toward the reflection unit 25.

### [Operation of Sensor Module 10]

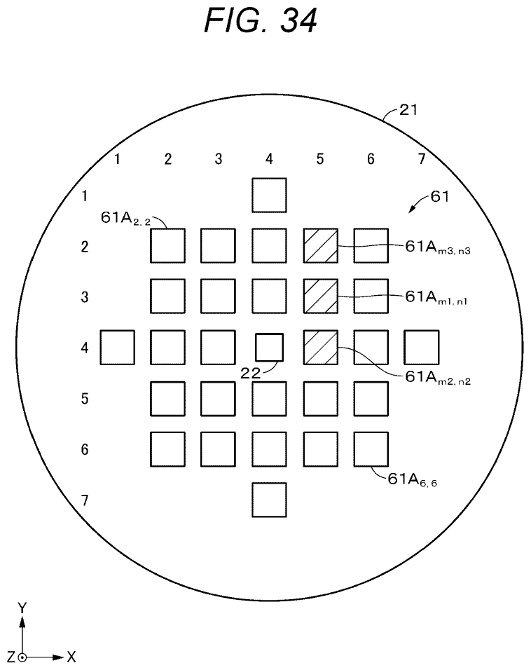

Hereinafter, an example of the detection operation of the forces F_{X} and F_{Y} by the sensor module 10 will be described with reference to FIGS. 34 to 37.

First, the IC 11 sequentially scans the plurality of two-dimensionally arranged light receiving units 61A_{m,n}, and obtains an output signal Smn from each light receiving unit 61A_{m,n}. Next, the IC 11 uses the obtained plurality of output signals S_{m,n} to specify three light receiving units 61A_{m,n} (for example, light receiving units 61A_{m1,n1}, 61A_{m2,n2}, and 61A_{m3,n3} (hereinafter referred to as “top three light receiving units 61A_{m1,n1}, 61A_{m2,n2}, and 61A_{m3,n3}”)) having the highest received light intensity among the plurality of light receiving units 61A_{m,n}.

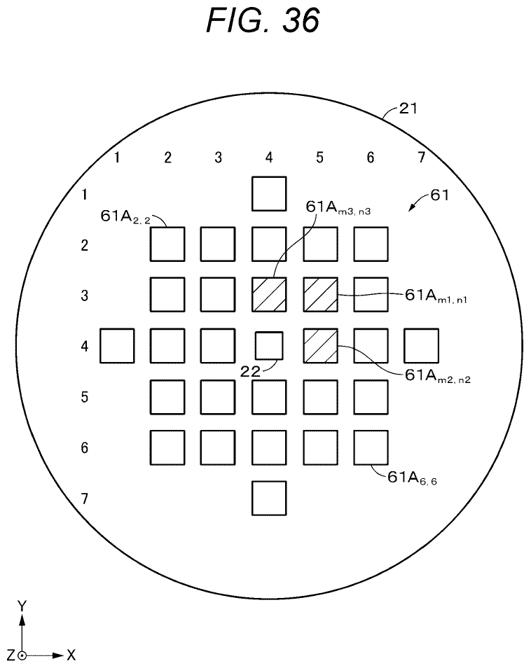

FIG. 34 illustrates an example in which the top three light receiving units 61A_{m1,n1}, 61A_{m2,n2}, and 61A_{m3,n3} are arranged in the Y direction (column direction). FIG. 36 illustrates an example in which two light receiving units 61A_{m1,n1} and 61A_{m2,n2} out of the top three light receiving units 61A_{m1,n1}, 61A_{m2,n2}, and 61A_{m3,n3} are arranged in the Y direction (column direction), and two light receiving units 61A_{m1,n1} and 61A_{m3,n3} are arranged in the X direction (row direction).

Next, the IC 11 selects the row 61M of the light receiving units 61A_{m,n} and the column 61N of the light receiving units 61A_{m,n} used for calculating the forces F_{X} and F_{Y}.

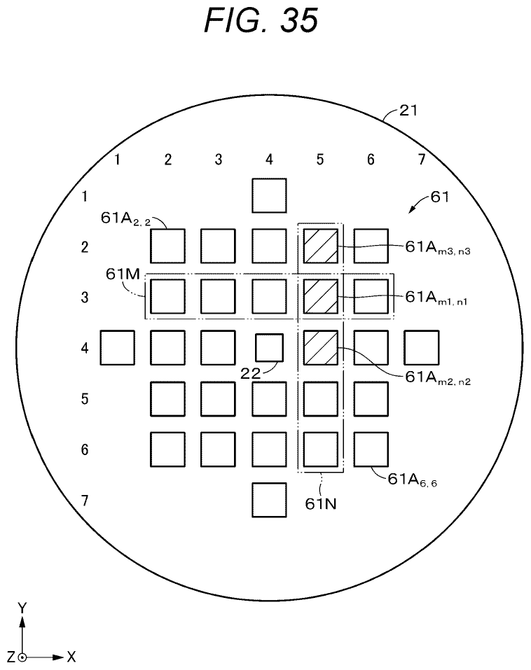

For example, as illustrated in FIG. 34, in a case where the top three light receiving units 61A_{m1,n1}, 61A_{m2,n2}, and 61A_{m3,n3} are arranged in the Y direction (column direction), the IC 11 selects the column 61N of the light receiving units 61A_{m,n} including the top three light receiving units 61A_{m1,n1}, 61A_{m2,n2}/and 61A_{m3,n3} as illustrated in FIG. 35. Further, as illustrated in FIG. 35, the IC 11 selects the row 61M of the light receiving units 61A_{m,n} including 61A_{m1,n1} located at the center among the top three three light receiving units 61A_{m1,n1}, 61A_{m2,n2}, and 61A_{m3,n3}.

In a case where the top three light receiving units 61A_{m1,n1}; 61A_{m2,n2}, and 61A_{m3,n3} are arranged in the X direction (column direction), the IC 11 selects the row 61M of the light receiving units 61A_{m,n} including the top three light receiving units 61A_{m1,n1}, 61A_{m2,n2}, and 61A_{m3,n3}. In addition, the IC 11 selects the column 61N of the light receiving units 61A_{m1,n1} including 61A_{m,n} located at the center among the top three three light receiving units 61A_{m1,n1}, 61A_{m2,n2}, and 61A_{m3,n3}.

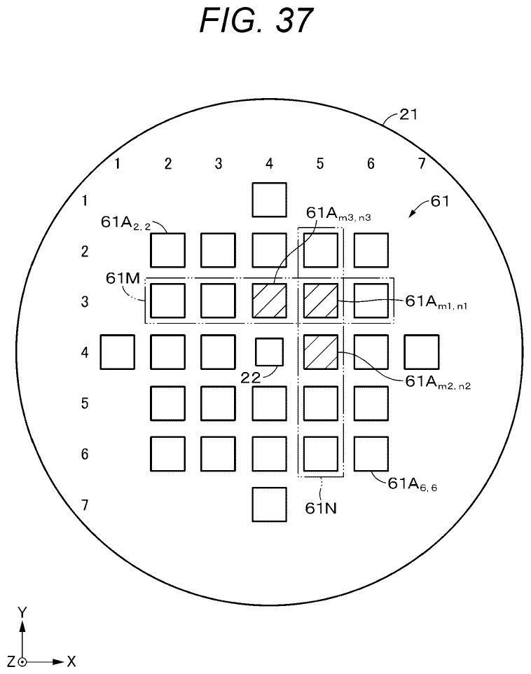

As illustrated in FIG. 36, in a case where the top three light receiving units 61A_{m1,n1}, 61A_{m2,n2}, and 61A_{m3,n3} are arranged in the X direction (row direction) and the Y direction (column direction), the IC 11 selects the column 61N of the light receiving units 61A_{m,n} including two light receiving units 61A_{m1,n1}, and 61A_{m2,n2} arranged in the Y direction (column direction) as illustrated in FIG. 37. Further, as illustrated in FIG. 37, the IC 11 selects the row 61M of the light receiving units 61A_{m,n} including the two light receiving units 61A_{m1,n1} and 61A_{m3,n3} arranged in the X direction (row direction).

Next, the IC 11 calculates the forces F_{X} and F_{Y} using the row 61M of the light receiving units 61A_{m,n} and the column 61N of the light receiving units 61A_{m,n} selected as described above. The calculation operation of the forces F_{X} and F_{Y} is similar to the second detection operation (see FIG. 13) of the forces F_{X} and F_{Y} by the sensor module 10 in the first embodiment except that the row 61M of the light receiving units 61A_{m,n} and the column 61N of the light receiving units 61A_{m,n} selected as described above are used.

### <Modification 13>

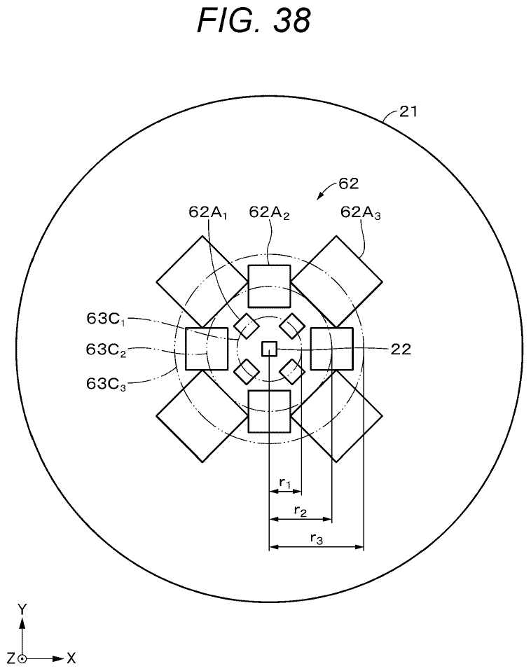

FIG. 38 is a plan view illustrating an example of a configuration of a light receiving unit group 62 of Modification 13. In Modification 13, the X axis and the Y axis are referred to as a first axis and a third axis, respectively, and axes rotated by 45° and 135° with respect to the X axis are referred to as a second axis and a fourth axis, respectively. A circle 63Cₙ (here, n is a positive integer) represents a virtual circle centered on the geometric center of the light source 22 in plan view and having a radius rₙ. In addition, it is assumed that the circle 63Cₙ having a larger value of n has a larger radius rₙ and is located on the outer side. A difference Δr (=rₙ₊₁−rₙ) between the radii of the adjacent circles 63Cₙ and 63Cₘ₊₁ may be a constant value regardless of the value of n, or may change depending on the value of n.

The light receiving unit group 62 includes a plurality of light receiving units 62Aₙ. In the circle 63Cₙ, four light receiving units 62Aₙ are arranged at equal intervals. The four light receiving units 62Aₙ are arranged at equal intervals such that the geometric center is located at an intersection of a circle 63Cₙ having a radius rₙ and the second axis and the fourth axis. The four light receiving units 62Aₙ₊₁ are arranged at equal intervals such that the geometric center is located at an intersection of a circle 63Cₘ₊₁ having a radius rₙ₊₁ and the first axis and the third axis. That is, the arrangement positions (geometric center positions) of the four light receiving units 62Aₙ₊₁ are positions shifted by Δr in the radial direction and shifted by Δθ(=45°) in the circumferential direction from the arrangement positions (geometric center positions) of the four light receiving units 62Aₙ. The light receiving unit 62Aₙ farther from the center of the light receiving unit group 62, that is, the geometric center of the light source 22 preferably has a larger region of the light receiving region of the light receiving unit 62Aₙ in plan view.

The four light receiving units 62Aₙ located on the circle 63Cₙ constitute a first light receiving unit pair and a second light receiving unit pair. The first light receiving unit pair is a pair of light receiving units 62Aₙ corresponding to each other in the direction of the first axis or the second axis. The second light receiving unit pair is a pair of light receiving units 62Aₙ corresponding to each other in the direction of the third axis or the fourth axis. The IC 11 may detect the forces F_{X}, F_{Y}, and F_{Z} acting on the sensor 20 based on the outputs of the first light receiving unit pair and the second light receiving unit pair located in the same circle 63Cₙ. As the height of the reflection unit 25 becomes smaller (the reflection unit 25 approaches the light source 22), the IC 11 may detect the forces F_{X}, F_{Y}, and F_{Z} acting on the sensor 20 using the first light receiving unit pair and/or the second light receiving unit pair closer to the geometric center of the light source 22.

As described above, since the four light receiving units 62Aₙ located in the circle 63Cₙ and the four light receiving units 62Aₙ₊₁ located in the circle 63Cₘ₊₁ adjacent to the circle 63C, are arranged to be shifted in the radial direction and the circumferential direction, the four light receiving units 62Aₙ₊₁ located in the circle 63Cₘ₊₁ can be made larger than the four light receiving units 62A, located in the circle 63Cₙ.

In a case where the reflection unit 25 is close to the light source 22, the IC 11 may detect the forces F_{X}, F_{Y}, and F_{Z} acting on the sensor 20 on the basis of the outputs of the first light receiving unit pair and the second light receiving unit pair close to the geometric center of the light source 22. The first light receiving unit and the second light receiving unit close to the geometric center of the light source 22 have a small area, but in a case where the reflection unit 25 is close to the light source 22, the intensity of light incident on the first light receiving unit and the second light receiving unit is high, so that sensing can be performed with high sensitivity.

On the other hand, in a case where the reflection unit 25 is far from the light source 22, the IC 11 may detect the forces F_{X}, F_{Y}, and F_{Z} acting on the sensor 20 on the basis of the outputs of the first light receiving unit pair and the second light receiving unit pair far from the geometric center of the light source 22. Although the intensity of the light incident on the first light receiving unit and the second light receiving unit far from the geometric center of the light source 22 is low, the first light receiving unit and the second light receiving unit far from the geometric center of the light source 22 have a large area. Therefore, even if the intensity of the incident light is low, a sufficient amount of received light can be obtained in the first light receiving unit and the second light receiving unit, and sensing can be performed with high sensitivity.

### (Other Modifications)

The above embodiment and modifications thereof of the present disclosure have been specifically described above, but the present disclosure is not limited to the above embodiment and modifications thereof, and various modifications based on the technical idea of the present disclosure may be made.

For example, configurations, methods, processes, shapes, materials, numerical values, and the like in the above embodiment and modifications are merely examples, and different configurations, methods, processes, shapes, materials, numerical values, and the like may be employed as necessary.

The configurations, methods, processes, shapes, materials, numerical values, and the like of the above embodiment and modifications can be combined with each other without departing from the gist of the present disclosure.

The materials exemplified in the above embodiment and modifications may be used alone or in combination of two or more unless otherwise specified.

In the above embodiment, an example in which the sensor 20 includes the elastic body 24 has been described, but the sensor 20 may have a hollow structure without including the elastic body 24. In this case, the light shielding layer 26 may have self-standing and elasticity.

In the above embodiment, the IC 11 may calculate a sum SZ₃ (=S_{A3}+S_{A4}+S_{B3}+S_{B4}) of the output signals using the output signals S_{A3} and S_{A4} of the pair of the first light receiving units 23A₃ and 23A₄ and the output signals S_{B3} and S_{B4} of the pair of the second light receiving units 23B₃ and 23B₄. In this case, the IC 11 may operate as follows.

In a case where the distance between the center position of the reflection unit 25 and the base material 21 is larger than a first specified value, the IC 11 calculates the force F_{Z} acting in the Z direction on the basis of the sum SZ₁ of the output signals, and outputs the force F_{Z} to the main CPU12A. In a case where the distance between the center position of the reflection unit 25 and the base material 21 is larger than the second specified value and equal to or smaller than the first specified value, the IC 11 calculates the force F_{Z} acting in the Z direction on the basis of the sum SZ₂ of the output signals, and outputs the force F_{Z} to the main CPU12A. In a case where the distance between the center position of the reflection unit 25 and the base material 21 is equal to or less than the second specified value, the IC 11 calculates the force F_{Z} acting in the Z direction on the basis of the sum SZ₃ of the output signals, and outputs the force F_{Z} to the main CPU12A.

The IC 11 determines whether the distance between the center position of the reflection unit 25 and the base material 21 is larger than the first specified value on the basis of whether the sum SZ₁ of the output signals is larger than the first specified value SZ_{A}. The IC 11 determines whether the distance between the center position of the reflection unit 25 and the base material 21 is larger than the second specified value and equal to or smaller than the first specified value on the basis of whether the sum SZ₁ of the output signals is larger than a second specified value SZ_{B} and equal to or smaller than the first specified value SZ_{A}. The IC 11 determines whether the distance between the center position of the reflection unit 25 and the base material 21 is equal to or less than the second specified value on the basis of whether the sum SZ₁ of the output signals is equal to or less than the second specified value SZ_{B}.

In the above embodiment, the example in which the IC 11 calculates the force F_{Z} from the sum SZ₁ of the output signals or the sum SZ₂ of the output signals and outputs the force F_{Z} to the main CPU 12A has been described. However, the present disclosure is not limited to this example, and for example, the IC 11 may output the sum SZ₁ of the output signals or the sum SZ₂ of the output signals to the main CPU12A. More specifically, in a case where the distance between the center position of the reflection unit 25 and the base material 21 is larger than the specified value, the IC 11 may output the sum SZ₁ of the output signals to the main CPU 12A, and in a case where the distance between the center position of the reflection unit 25 and the base material 21 is smaller than the specified value, the IC 11 may output the sum SZ₂ of the output signals to the main CPU 12A.

In the above embodiment, an example has been described in which the IC 11 calculates the force F_{X}, the force F_{Y}, and the force F_{Z} from the difference SX between the output signals, the difference SY between the output signals, and the sum SZ of the output signals, and outputs the force F_{X}, the force F_{Y}, and the force F_{Z} to the main CPU 12A. However, the present disclosure is not limited to this example, and for example, the IC 11 may output the difference SX between the output signals, the difference SY between the output signals, and the sum SZ of the output signals to the main CPU12A.

Furthermore, the present disclosure may also employ the following configurations.
(1) A force sensor including:
a light receiving unit group;
a reflection unit provided above the light receiving unit group; and
an elastic body provided between the reflection unit and the light receiving unit group,
in which the light receiving unit group includes
four or more first light receiving units arranged in a first direction, and
four or more second light receiving units arranged in a second direction orthogonal to the first direction.
(2) The force sensor according to (1),
in which the first light receiving unit and the second light receiving unit farther from a center of the light receiving unit group has a larger region of a light receiving region.
(3) The force sensor according to (1),
in which the four or more first light receiving units are arranged symmetrically with respect to a center of the light receiving unit group, and
the four or more second light receiving units are arranged symmetrically with respect to the center of the light receiving unit group.
(4) The force sensor according to any one of (1) to (3), further including:
a light source provided at a position corresponding to the reflection unit; and
a lens provided on the light source or above the light source.
(5) The force sensor according to any one of (1) to (4),
in which each of the first light receiving units and the second light receiving units includes one section of light receiving elements included in an image sensor.
(6) The force sensor according to any one of (1) to (5), further including
a light shielding layer,
in which the light shielding layer covers the elastic body and the reflection unit.
(7) The force sensor according to (6),
in which the elastic body includes an upper surface and a side surface, and
the light shielding layer covers the upper surface and the side surface.
(8) The force sensor according to any one of (1) to (7),
in which the reflection unit includes a light scattering body.
(9) The force sensor according to any one of (1) to (3), further including
a base material layer including a light source,
in which the four or more first light receiving units and the four or more second light receiving units are provided on the base material layer, and
the base material layer has a hole through which light can be extracted to the elastic body.
(10) The force sensor according to any one of (1) to (3), further including
a light guiding layer,
in which the light guiding layer has a hole through which light can be extracted to the elastic body.
(11) The force sensor according to any one of (1) to (10), further including
a protrusion at a position corresponding to the reflection unit.
(12) The force sensor according to any one of (1) to (11), further including:
a wavelength conversion layer provided between the elastic body and the reflection unit; and
a color filter that covers the light receiving unit group,
in which the wavelength conversion layer is capable of converting first light emitted from a light source into second light, and
the color filter is capable of absorbing the first light and transmitting the second light.
(13) The force sensor according to any one of (1) to (12), further including:
a light transmission layer provided between the elastic body and the light receiving unit group; and
a lens capable of forming an image of the reflection unit in the light transmission layer.
(14) The force sensor according to any one of (1) to (13),
in which the number of the first light receiving units arranged in the first direction is six or more, and
the number of the second light receiving units arranged in the second direction is six or more.
(15) A force sensor including:
a plurality of light receiving unit groups;
a plurality of reflection units provided above each of the light receiving unit groups; and
an elastic layer provided between the plurality of reflection units and the plurality of light receiving unit groups,
in which the light receiving unit group includes
four or more first light receiving units arranged in a first direction, and
four or more second light receiving units arranged in a second direction orthogonal to the first direction.
(16) The force sensor according to (15),
in which the elastic layer includes a groove between the adjacent light receiving unit groups in plan view.
(17) The force sensor according to (15) or (16), further including:
a light transmission layer provided between the elastic layer and the plurality of light receiving unit groups; and
a plurality of lenses that form images of the plurality of reflection units in the light transmission layer.
(18) A sensor module including:
the sensor according to any one of (1) to (17); and
a detection unit,
in which the detection unit
selects a difference between output signals included in a first linear region from among differences between output signals of a pair of the first light receiving units, and
selects a difference between output signals included in a second linear region from among differences between output signals of a pair of the second light receiving units.
(19) A sensor module including:
the sensor according to any one of (1) to (17); and
a detection unit,
in which the detection unit
selects a difference between output signals with a smallest detection error among differences between output signals of a pair of the first light receiving units, and
selects a difference between output signals with a smallest detection error among differences between output signals of a pair of the second light receiving units.
(20) A robot hand including
the force sensor according to any one of (1) to (17).

### 3 Application Example

### (Robot Hand)

The robot hand may include the sensor module 10 (that is, the sensor 20 and the IC 11) according to one embodiment described above. In this case, the sensor module 10 may include any one of the sensors 30A to 30J and 20K of Modifications 1 to 11 instead of the sensor 20. The sensor 20 and the sensors 30A to 30J and 20K may include the light receiving unit groups 61 and 62 of Modifications 12 and 13 instead of the light receiving unit group 23.

The robot hand may include any one of the sensor 20 of one embodiment and the sensors 30A to 30J and 20K of Modifications 1 to 11, and the control device or the like that controls the robot hand may include the IC 11. In this case, the sensor 20 and the sensors 30A to 30J and 20K may include the light receiving unit group 23, or may include the light receiving unit groups 61 and 62 of Modifications 12 and 13 instead of the light receiving unit group 23.

### Specific Example 1

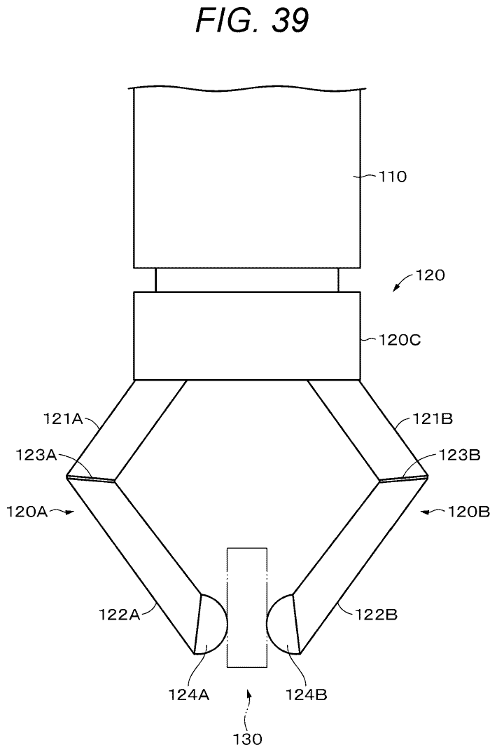

FIG. 39 is a schematic diagram illustrating an example of a configuration of a robot hand 120. The robot hand 120 is configured to be able to hold a workpiece 130. The robot hand 120 is provided at a distal end of a robot arm 110. The robot hand 120 is an example of an end effector. The robot hand 120 includes a link 120C and a plurality of fingers 120A and 120B. Here, an example in which the robot hand 120 includes two fingers 120A and 120B will be described, but the number of fingers is not limited thereto, and may be one or three or more.

The link 120C is connected to the robot arm 110. The link 120C may constitute a palm. The finger 120A and the finger 120B are connected to the link 120C. The finger 120A and the finger 120B are configured to be able to hold the workpiece 130.

The finger 120A includes two links 121A and 122A, a joint 123A, and a force sensor (first sensor) 124A. The finger 120B includes two links 121B and 122B, a joint 123B, and a force sensor (second sensor) 124B.

The joint 123A connects the link 121A and the link 122A. The finger 120A is configured to be bendable about the joint 123A. The joint 123B connects the link 121B and the link 122B. The finger 120B is configured to be bendable about the joint 123B. Here, an example in which the number of joints included in the fingers 120A and 120B is one will be described, but the number of joints may be two or more.

The force sensor (first sensor) 124A is provided at the fingertip of the finger 120A, that is, at the distal end of the link 122A. The force sensor (second sensor) 124B is provided at the fingertip of the finger 120B, that is, at the distal end of the link 122B.

The force sensors 124A and 124B may be the sensor 20 of one embodiment or any of the sensors 30A to 30J and 20K of Modifications 1 to 11. Although not illustrated in FIG. 39, each of the force sensors 124A and 124B is connected to the IC 11 (see FIG. 1). The IC 11 is connected to the main central processing unit (CPU) 12A included in the host device 12. The host device 12 is a control device that controls the robot arm 110 and the robot hand 120. The IC 11 may be provided in the robot hand 120 or may be provided in the control device.

The force sensor 124A is configured to be able to detect the pressure distribution and the shearing force of the fingertip of the finger 120A. The force sensor 124A detects the pressure distribution and the shearing force of the fingertip of the finger 120A on the basis of the control of the IC 11A, and outputs the detection result to the sensor IC 11A.

The force sensor 124B is configured to be able to detect the pressure distribution and the shearing force of the fingertip of the finger 120B. The force sensor 124B detects the pressure distribution and the shearing force of the fingertip of the finger 120B on the basis of the control of the IC 11A, and outputs the detection result to the sensor IC 11A.

### Specific Example 2

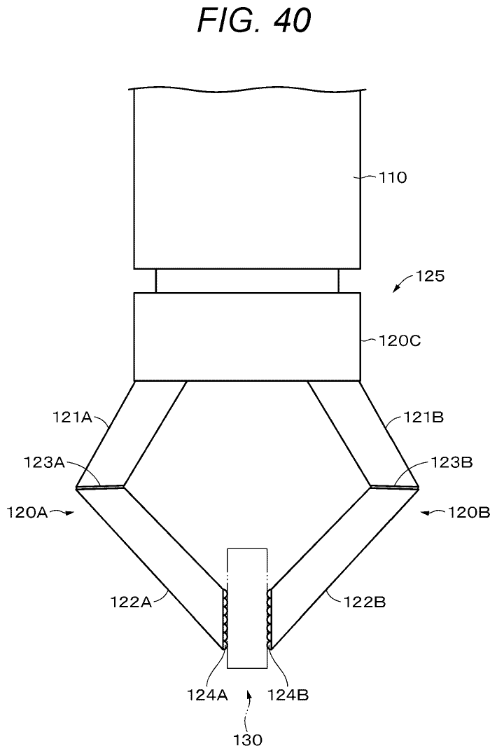

FIG. 40 is a schematic diagram illustrating an example of a configuration of a robot hand 125. The robot hand 125 is different from the robot hand 120 of Specific Example 1 in that a plurality of force sensors 124A are provided at the fingertip of the finger 120A, and a plurality of force sensors 124B are provided at the distal end of the fingertip of the finger 120B.

The plurality of force sensors 124A are two-dimensionally arranged on the fingertip of the finger 120A to constitute a tactile sensor. The plurality of force sensors 124B are two-dimensionally arranged on the fingertip of the finger 120B to constitute a tactile sensor.

### Specific Example 3

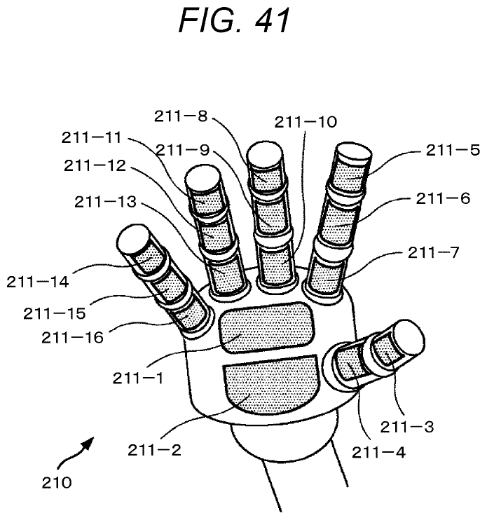

FIG. 41 is a schematic diagram illustrating a configuration of a robot hand 210 to which force sensors 211-1 to 211-16 are applied. The force sensors 211-1 to 211-16 may be the sensor 20 of one embodiment, or may be any one of the sensors 30A to 30J and 20K of Modifications 1 to 11. The force sensors 211-1 to 211-16 preferably have a film shape. Although not illustrated in FIG. 41, each of the force sensors 211-1 to 211-16 is connected to the IC 11 (see FIG. 1). The IC 11 is connected to the main central processing unit (CPU) 12A included in the host device 12. The host device 12 is a control device that controls the robot hand 210. The IC 11 may be provided in the robot hand 120 or may be provided in the control device.

The force sensors 211-1 and 211-2 are provided on the palm constituting the robot hand 210. The force sensor 211-3 is provided above the first joint on the palm surface of the thumb constituting the robot hand 210, and the force sensor 211-4 is provided between the first joint and the second joint. The force sensor 211-5 is provided above the first joint on the palm surface of the index finger, the force sensor 211-6 is provided between the first joint and the second joint, and the force sensor 211-7 is provided between the second joint and the third joint.

Furthermore, the force sensor 211-8 is provided above the first joint on the palm surface of the middle finger, the force sensor 211-9 is provided between the first joint and the second joint, and the force sensor 211-10 is provided between the second joint and the third joint. The force sensor 211-11 is provided above the first joint on the palm surface of the ring finger, the force sensor 211-12 is provided between the first joint and the second joint, and the force sensor 211-13 is provided between the second joint and the third joint. The force sensor 211-14 is provided above the first joint on the palm surface of the little finger, the force sensor 211-15 is provided between the first joint and the second joint, and the force sensor 211-16 is provided between the second joint and the third joint.

The robot hand 125 may include a sensor array instead of the force sensors 211-1 to 211-16. The sensor array may include a plurality of two-dimensionally arranged sensors. The sensor array may constitute a tactile sensor. As the sensor constituting the sensor array, the sensor 20 of one embodiment may be used, or any one of the sensors 30A to 30J and 20K of Modifications 1 to 11 may be used.

### REFERENCE SIGNS LIST

10 Sensor module
11 IC
12 Host device
12A Main CPU
20, 20K Sensor
20L Central axis
21 Base material
22 Light source
23 Light receiving unit group
23A₁, 23A₂, 23A₃ First light receiving unit
23B₁, 23B₂, 23B₃ Second light receiving unit
24 Elastic body
25 Reflection unit
26 Light shielding layer
30A, 30B, 30C, 30D, 30E, 30F, 30G, 30H, 30I, 30J Sensor
30L Central axis
30SE Sensor unit
31 Base material layer
31A Base material
31B Bonding layer
31C Light transmission layer
31D Light shielding layer
31DA, 31EA Pinhole
31 DB Hole
32 Elastic layer
32A Groove
33 Light shielding layer
34 Light guiding layer
34A, 34B Reflection layer
34BA, 34CA Pinhole
34CB Hole
35 Light source
36 Protrusion
37 Wavelength conversion layer
38 Color filter
41 Color filter
42 Light transmission layer
43 Light shielding layer
43A Hole
44 Light guiding layer
44A, 44B Reflection layer
44AA Hole
45 Lens
46 Wavelength conversion layer
46A Image
47 Light source
51, 52 Lens
61, 62 Light receiving unit group
61An, m, 62A, Light receiving unit
61AE Light receiving element
70S Irradiation surface
70P Center position
71A₁, 71A₂ First light receiving unit
71B₁, 71B₂ Second light receiving unit
72 Point light source
110 Robot arm
120, 125, 210 Robot hand
120A, 120B Finger
120C Link
124A, 124B Force sensor
211-1 to 211-16 Force sensor

1. A force sensor comprising:
a light receiving unit group;
a reflection unit provided above the light receiving unit group; and
an elastic body provided between the reflection unit and the light receiving unit group,
wherein the light receiving unit group includes
four or more first light receiving units arranged in a first direction, and
four or more second light receiving units arranged in a second direction orthogonal to the first direction.

2. The force sensor according to claim 1,
wherein the first light receiving unit and the second light receiving unit farther from a center of the light receiving unit group has a larger region of a light receiving region.

3. The force sensor according to claim 1,
wherein the four or more first light receiving units are arranged symmetrically with respect to a center of the light receiving unit group, and
the four or more second light receiving units are arranged symmetrically with respect to the center of the light receiving unit group.

4. The force sensor according to claim 1, further comprising:
a light source provided at a position corresponding to the reflection unit; and
a lens provided on the light source or above the light source.

5. The force sensor according to claim 1,
wherein each of the first light receiving units and the second light receiving units includes one section of light receiving elements included in an image sensor.

6. The force sensor according to claim 1, further comprising
a light shielding layer,
wherein the light shielding layer covers the elastic body and the reflection unit.

7. The force sensor according to claim 6,
wherein the elastic body includes an upper surface and a side surface, and
the light shielding layer covers the upper surface and the side surface.

8. The force sensor according to claim 1,
wherein the reflection unit includes a light scattering body.

9. The force sensor according to claim 1, further comprising
a base material layer including a light source,
wherein the four or more first light receiving units and the four or more second light receiving units are provided on the base material layer, and
the base material layer has a hole through which light can be extracted to the elastic body.

10. The force sensor according to claim 1, further comprising
a light guiding layer,
wherein the light guiding layer has a hole through which light can be extracted to the elastic body.

11. The force sensor according to claim 1, further comprising
a protrusion at a position corresponding to the reflection unit.

12. The force sensor according to claim 1, further comprising:
a wavelength conversion layer provided between the elastic body and the reflection unit; and
a color filter that covers the light receiving unit group,
wherein the wavelength conversion layer is capable of converting first light emitted from a light source into second light, and
the color filter is capable of absorbing the first light and transmitting the second light.

13. The force sensor according to claim 1, further comprising:
a light transmission layer provided between the elastic body and the light receiving unit group; and
a lens capable of forming an image of the reflection unit in the light transmission layer.

14. The force sensor according to claim 1,
wherein the number of the first light receiving units arranged in the first direction is six or more, and
the number of the second light receiving units arranged in the second direction is six or more.

15. A force sensor comprising:
a plurality of light receiving unit groups;
a plurality of reflection units provided above each of the light receiving unit groups; and
an elastic layer provided between the plurality of reflection units and the plurality of light receiving unit groups,
wherein the light receiving unit group includes
four or more first light receiving units arranged in a first direction, and
four or more second light receiving units arranged in a second direction orthogonal to the first direction.

16. The force sensor according to claim 15,
wherein the elastic layer includes a groove between the adjacent light receiving unit groups in plan view.

17. The force sensor according to claim 15, further comprising:
a light transmission layer provided between the elastic layer and the plurality of light receiving unit groups; and
a plurality of lenses that form images of the plurality of reflection units in the light transmission layer.

18. A sensor module comprising:
the sensor according to claim 1; and
a detection unit,
wherein the detection unit
selects a difference between output signals included in a first linear region from among differences between output signals of a pair of the first light receiving units, and
selects a difference between output signals included in a second linear region from among differences between output signals of a pair of the second light receiving units.

19. A sensor module comprising:
the sensor according to claim 1; and
a detection unit, wherein
the detection unit
selects a difference between output signals with a smallest detection error among differences between output signals of a pair of the first light receiving units, and
selects a difference between output signals with a smallest detection error among differences between output signals of a pair of the second light receiving units.

20. A robot hand comprising
the force sensor according to claim 1.
